(19) United States
(12) Patent Application Publication
(10) Pub. No.: US 2026/0073090 A1
(43) Pub. Date: Mar. 12, 2026

(54) THERMAL MODELING OF ADDITIVE MANUFACTURING

(71) Applicant: NUTECH VENTURES, Lincoln, NE (US)

(72) Inventors: Kevin COLE, Lincoln, NE (US); Alex RIENSCHE, Lincoln, NE (US); Prahalada RAO, Lincoln, NE (US)

(21) Appl. No.: 18/705,783

(22) PCT Filed: Oct. 28, 2022
(86) PCT No.: PCT/US2022/048296

§ 371 Date: Apr. 29, 2024

Related U.S. Application Data
(60) Provisional application No. 63/273,341, filed on Oct. 29, 2021.
(60) Provisional application No. 63/287,816, filed on Dec. 9, 2021.

(51) Int. Cl. G06F 30/20; B29C 64/386; B33Y 50/00; G06F 113/10; G06F 119/08

(52) U.S. Cl. CPC G06F 30/20; B29C 64/386; B33Y 50/00; G06F 2113/10; G06F 2119/08

(57) ABSTRACT

Methods, systems, and apparatus, including computer programs encoded on a computer storage medium, for an additive manufacturing heat transfer simulation process. The process includes converting a model of an object into a node representation of the object and generating a network graph of the object based on the node representation. For each block of nodes in the node representation the process includes: applying a simulated heat to the block of nodes by multiple causation functions, performing an energy balance of heat flow into and out of the node to determine the energy stored in the node, and estimating a diffusion of heat to other nodes using physics based edge weights between nodes in the network graph. The process includes generating a representation of an estimated heat distribution within the object.

### CROSS-REFERENCE TO RELATED APPLICATIONS

This application claims the benefit of priority to U.S. Provisional Application Ser. No. 63/273,641, filed Oct. 29, 2021 and U.S. Provisional Application Ser. No. 63/287,816, filed on Dec. 9, 2021. The disclosure of the prior applications are considered part of and are incorporated by reference in the disclosure of this application.

### FEDERALLY SPONSORED RESEARCH OR DEVELOPMENT

This invention was made with government support under Grant No. IIP-2044710 awarded by the U.S. National Science Foundation and Grant No. DE-SC0021136 by the U.S. Department of Energy. The government has certain rights in the invention.

### TECHNICAL FIELD

This disclosure relates to improvements to additive manufacturing processes.

### BACKGROUND

Additive manufacturing (e.g., three-dimensional printing) is a process in which layers of material are sequentially applied and fused together. Inadequate heat dissipation can lead to failure of AM manufactured parts.

Metal additive manufacturing (AM/3D printing) offers unparalleled advantages over conventional manufacturing, including greater design freedom and a lower lead time. However, the use of AM parts in safety-critical industries, such as aerospace and biomedical, is limited by the tendency of the process to create flaws that can lead to sudden failure during use. The root cause of flaw formation in metal AM parts, such as porosity and deformation, is linked to the temperature inside the part during the process, called the thermal history. The thermal history is a function of the process parameters and part design.

Consequently, the first step towards ensuring consistent part quality in metal AM is to understand how and why the process parameters and part geometry influence the thermal history. Given the current lack of scientific insight into the causal design-process-thermal physics link that governs part quality, AM practitioners resort to expensive and time-consuming trial-and-error tests to optimize part geometry and process parameters.

An approach to reduce extensive empirical testing is to identify the viable process parameters and part geometry combinations through rapid thermal simulations. However, a major barrier that deters physics-based design and process optimization efforts in AM is the prohibitive computational burden of existing finite element-based thermal modeling.

### DESCRIPTION OF DRAWINGS

FIG. 1A illustrates an LPBF process schematic and FIG. 1B illustrates a DED process schematic in which metal powder is sprayed via nozzles and fused onto a substrate by a laser beam.

FIG. 2 illustrates lack-of-fusion defects in a titanium part made with LPBF. These same defects are common in DED.

FIG. 3 illustrates salient thermal phenomena in DED include conductive, convective, and radiative heat transfer.

FIG. 4 illustrates experimental data for each deposition case along with the corresponding thermocouple location and dwell time.

FIG. 5A illustrates a schematic of the clamped substrate in relation to the thin wall, FIG. 5B illustrates the wall constructed in case A and case B, and FIG. 5C illustrates the wall constructed in case C.

FIG. 6 illustrates the thermocouple locations for each case.

FIG. 7A illustrates an example process for modeling heat flux in AM parts that can be executed in accordance with implementations of the present disclosure.

FIG. 7B illustrates representation of the four steps in the graph-theoretic approach for the DED process.

FIG. 7C illustrates a graphical illustration of the conversion of a three-dimensional model of an AM part into a node representation.

FIG. 7D illustrates a graphical representation of nodes being sorted into layers.

FIG. 7E illustrates a graphical representation of nodes being sorted into hatches.

FIG. 7F illustrates a graphical representation of generating a weight for a node of an adjacency matrix based on neighbouring nodes.

FIG. 8 illustrates a block-by-block heating scheme used in graph theory DED simulation.

FIG. 9 illustrates snapshots of the graph theory-based simulation for each case. The lack of dwell time in Case B and Case C leads to accumulation of heat in the top layers of the part.

FIG. 10 illustrates an example boundary node with thermal resistance for heat loss to surroundings at T_{∞}.

FIG. 11 illustrates diagrams of an example geometry for heat flow between nodes for (a) 1-D uniform grid (b) 3-D uniform rectangular grid (c) 3-D random grid.

FIG. 12 illustrates a schematic diagram of a slab with piecewise internal heating, one insulated boundary, and one convection boundary used in a first example simulation case.

FIG. 13 illustrates several graphs of temperature results for the first example simulation case for heating over (0<x/a<0.30) (a) temperature at insulated surface x=0; (b) temperature at t=1.0; and, (c) temperature at Biot=1 at four times.

FIG. 14 illustrates several graphs showing results for the first example simulation case for piecewise heating over (0<x/a<0.30), under conditions B₂=1.0, nt=20, and nx=20, for spectral graph (SG), finite difference (FD), and exact solutions. (a) Temperature history at the node nearest x=0, (b) temperature distribution at \tilde{t}=0.5, (c) relative error for the temperature history, (d) relative error for the temperature distribution.

FIG. 15 illustrates a schematic diagram of a slab with suddenly applied convection at the x=0 boundary and convection cooling at x=L used in a second example simulation case.

FIG. 16 illustrates several graphs of temperature results for the second example simulation case for suddenly-applied convection heating at the x=0 boundary. (a) Temperature at the heated surface for three Biot values; (b) temperature at \tilde{t}=0.5 for three Biot values; and, (c) temperature at Biot=1 at four times.

FIG. 17 illustrates several graphs showing results for the second example simulation case at B₁=B₂=1.0, nt=20, and nx=20, for suddenly-applied convection heating at the x=0 boundary, for spectral graph (SG), finite difference (FD), and exact solutions. (a) Temperature history at the node nearest x=0, (b) temperature distribution at \tilde{t}=0.5, (c) relative error for the temperature history, (d) relative error for the temperature distribution.

FIG. 18 illustrates a schematic diagram of a geometry for a third simulation example case of a parallelepiped with piecewise initial condition and convection heat loss at the boundaries.

FIG. 19 illustrates a diagram showing locations for observing temperature in the parallelepiped of the third Example simulation case.

FIG. 20 illustrates graphs of the temperature history at the three locations of the parallelepiped indicated in FIG. 19 to compare exact and SG solution performance on a uniform rectangular grid of the parallelepiped at Biot=0.1, Biot=1.0, and Biot 10.

FIG. 21 illustrates a graph of average gain versus node density (n vol) at several Biot numbers. For each node density n vol, ten block-random grids were used to find averages; error bars show the variance.

FIG. 22 illustrates graphs of the temperature history at the three locations of the parallelepiped indicated in FIG. 19 to compare exact and SG solution performance on a block random grid of the parallelepiped at Biot=0.1, Biot=1.0, and Biot 10.

FIG. 23 illustrates a schematic diagram of open architecture LPBF platform and the LWIR camera setup used to perform a comparison of the SG simulation method with a test build of a laser powder bed fusion (LPBF) process.

FIG. 24 illustrates a diagram of the inverted half cone geometry used to experimentally validate the SG simulation method disclosed herein and a photograph of a build plate of two post build half cone geometry parts.

FIG. 25A illustrates an infrared image showing the 9 pixel by 9 pixel area over which the surface temperature trends are averaged for the C45 cone-shaped test artifact.

FIG. 25B illustrates a graph of surface temperature trends for the entire duration of the build.

FIG. 25C illustrates a graph of a zoomed in area of the temperature trends over three process cycles.

FIG. 25D illustrates a graph showing the end-of-cycle surface temperature for the duration of build corresponding to the C45 cone-shaped test artifact.

FIG. 25E illustrates a diagram of process events that cause the three epochs observed in the temperature trends shown in in FIG. 25C

FIG. 26 illustrates graphs of the end-of-cycle temperature histories for the inverted half cone parts C40 and C45.

FIG. 27 illustrates a graph representing results of a convergence study on node density for a 50-layer simulated build of the C40 inverted half cone, compared to experimental data.

FIG. 28 illustrates an example computing system, according to implementations of the present disclosure.

Like reference symbols in the various drawings indicate like elements.

### DETAILED DESCRIPTION

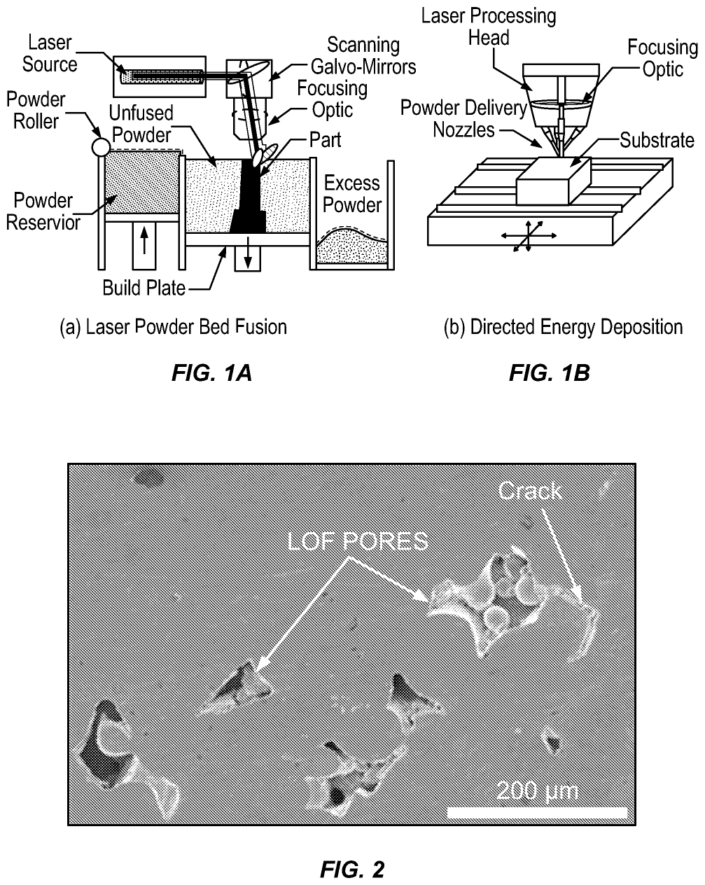

Metal additive manufacturing (AM) processes, such as laser powder bed fusion (LPBF) and directed energy deposition (DED), offer considerable advantages over other conventional manufacturing methods. While noteworthy differences between the two AM processes are discussed later, schematics of LPBF and DED are presented in FIG. 1. Compared to conventional subtractive processes, AM often requires lower lead times and allows for greater design freedom. However, inconsistencies in the process and part quality currently prevent AM from being widely accepted in critical applications. The part is often pervaded by heterogeneous microstructures and defects, such as pores and cracks. Process parameters can directly lead to the formation of certain defects. For instance, FIG. 2 depicts one type of defect that is caused by a phenomenon known as lack of fusion (LOF). Although the defects in FIG. 2 are taken from an LPBF part, LOF also appears in DED. As the name suggests, it occurs when the laser power is too low or the scan speed is too high, which results in incomplete melting of the metal powder particles. The part is then left with irregular voids, thus giving rise to potentially catastrophic stress concentrations.

The present disclosure provides a graph theory approach for thermal modeling for AM that employs discrete Green's functions through treatment of a generalized boundary condition. The graph theory approach for thermal modeling in AM has been published in the context of an LPBF thermal modeling process disclosed in International Patent Application PCT/US2019/051192, SIMULATING HEAT FLUX IN ADDITIVE MANUFACTURING, and U.S. patent application Ser. No. 17/499,402, THERMAL MODELING OF ADDITIVE MANUFACTURING USING GRAPH THEORY, the contents of which are hereby incorporated by reference in their entirety. In the spectral graph method the heat equation is solved over a discrete set of nodes. In the present disclosure the spectral graph method is combined with discrete Green's functions through treatment of a generalized boundary condition.

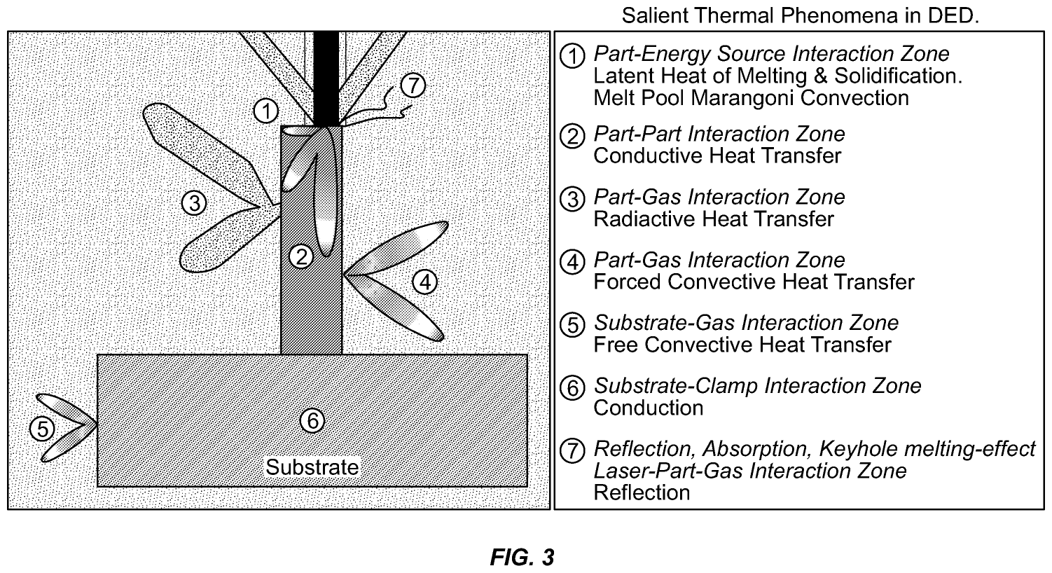

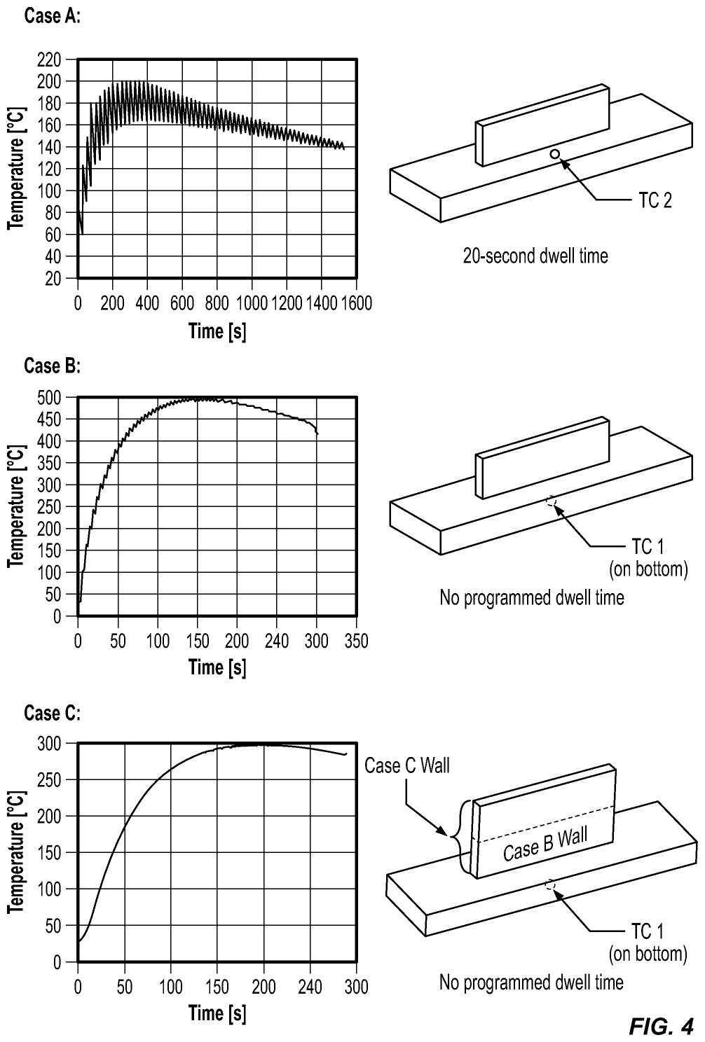

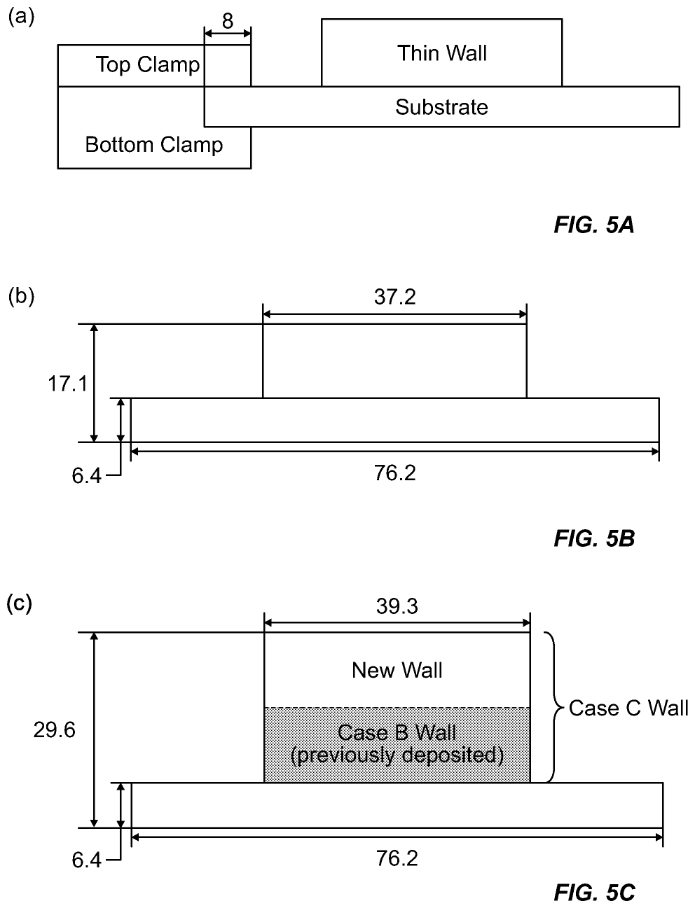

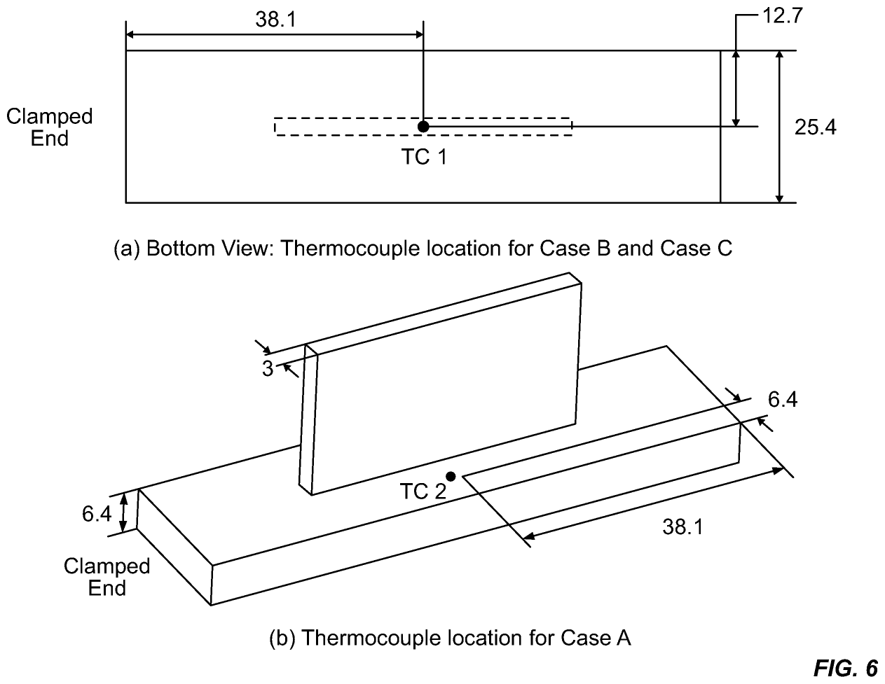

FIG. 3 outlines the salient thermal phenomena in DED. In FIG. 3, the phenomena labeled 3, 4, and 5 are unique to DED and are not present in the LPBF process. Consequently, certain heat transfer-related assumptions made in the context of the LPBF process to aid computation in LPBF simulations should be relaxed for the DED process.

A difference between LPBF and DED is that in the former process, the part is surrounded by unfused powder material, viz., an insulating medium. Hence, heat loss on the top surface of the part occurs through radiation and forced convective heat transfer from the melt pool. Heat loss in the rest of the LPBF part occurs largely through conduction, albeit, heat loss through free convection occurs at the part-powder boundaries given air gaps in the unfused metal powder surrounding the part.

In contrast, as shown in FIG. 3, the part in DED is surrounded not by metal powder but by an inert gas, and therefore heat is lost to the surroundings through convection and radiation from all surfaces. Convection involves both free and forced convection, as the metal powder is delivered to the substrate via an inert carrier gas, such as argon. Consequently, for a comprehensive model of part-level thermal history in DED, an accurate simulation will account for heat loss through conduction, e.g., both free and forced convection, and radiation. The thermal simulation has also been used for wire arc additive manufacturing (WAAM) for which the heat source is an electric arc, not a laser. This is a variation of the DED process as the growing part is surrounded by gas, not powder.

Second, the laser heat source-related assumptions in LPBF do not carry over to the DED process because the scan velocity and spot size (beam diameter) of the laser, and layer thickness are considerably different. In LPBF, the laser is moved by a set of mirrors and the mirrors are moved by galvanometers. By contrast, in DED, the laser head is translated by the physical motion of computer numerical controls (CNC), or in other words, CNC-based axes. Consequently, the scan velocity of the laser in DED is ten times slower compared to LPBF—the scan speed of the laser in LPBF is typically 200 to 500 mm·s⁻¹; in DED, the scan speed is on the order of 10 mm·s⁻¹. Further, the typical layer thickness is around 50 μm in LPBF, compared to ˜100 μm to 200 μm for DED. Lastly, the laser beam diameter in the DED process is typically nearer to the millimeter range compared to ˜50 μm to 100 μm in LPBF.

From a thermal modeling perspective, the higher laser scan velocity and smaller layer thickness of LPBF are advantageous for reducing the computation time. Researchers often simulate the deposition of multiple layers at a time in LPBF (called the super-layer or meta-layer assumption) to reduce the computation time. For example, one technique uses the meta-layer assumption in an FE-model to predict thermal-induced deformation in LPBF. Meta-layers ranging from 12 to as large as 50 times the actual layer thickness (50 μm) are simulated. Using this technique a model predicts distortion within 5% of measurements, despite simulating the deposition of ˜15 layers at a time. The slow scan speed and large laser spot size of DED ensure that the melt pool has a large diameter and penetrates deeper into the previous layers compared to LPBF. Consequently, the meta-layer assumption is not viable in DED.

The present disclosure provides a graph theory approach for thermal modeling for AM that employs discrete Green's functions through treatment of a generalized boundary condition. The graph theory approach for thermal modeling in AM has been published in the context of an LPBF thermal modeling process disclosed in International Patent Application PCT/US2019/051192, SIMULATING HEAT FLUX IN ADDITIVE MANUFACTURING, and U.S. patent application Ser. No. 17/499,402, THERMAL MODELING OF ADDITIVE MANUFACTURING USING GRAPH THEORY, the contents of which are hereby incorporated by reference in their entirety.

One advantage of the spectral graph (SG) method disclosed herein lies in the ease with which any geometry may be represented by a collection of nodes dispersed throughout the body. The inventors have shown in research that the SG method may be computed faster than commercial finite element codes for comparable precision, for thermal simulation of additive manufacturing. The research involved insulated boundaries, with boundary heat loss included as an adjustment to the boundary temperatures, external to the SG method.

An advantage of the Green's function (GF) method disclosed herein is that several types of heating conditions may be addressed with straightforward steps if the GF is known. Discrete building-block solutions can be constructed from the GF to treat heating conditions that vary over space and over time.

In the present work, the geometric universality and computational speed of the SG method is combined with the multiple-heating capability and mathematical rigor of the GF method. The improved method can treat boundary conditions of type 1, 2, and 3 (discussed below), under a variety of heat-addition conditions, and has great potential to provide rapid thermal simulations of a variety of industrial processes.

### General Simulation Procedure

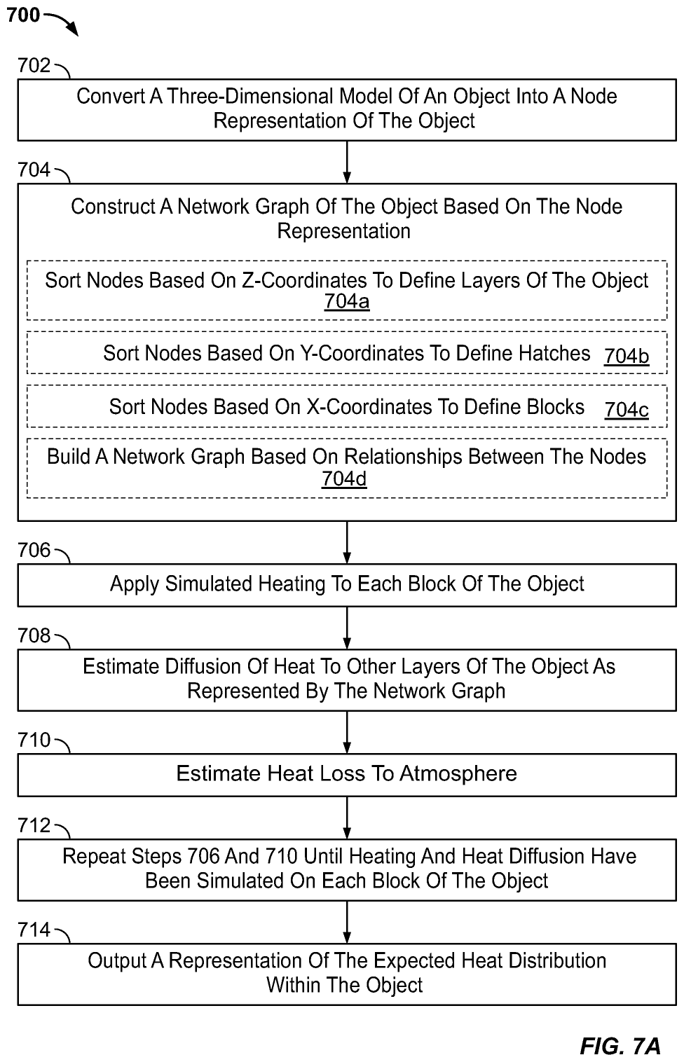

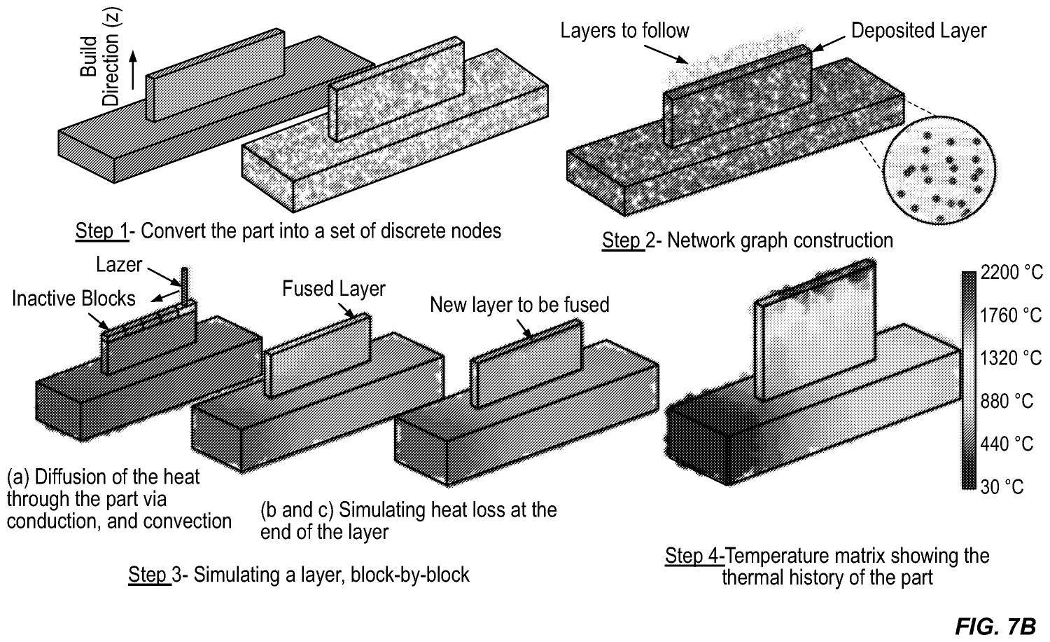

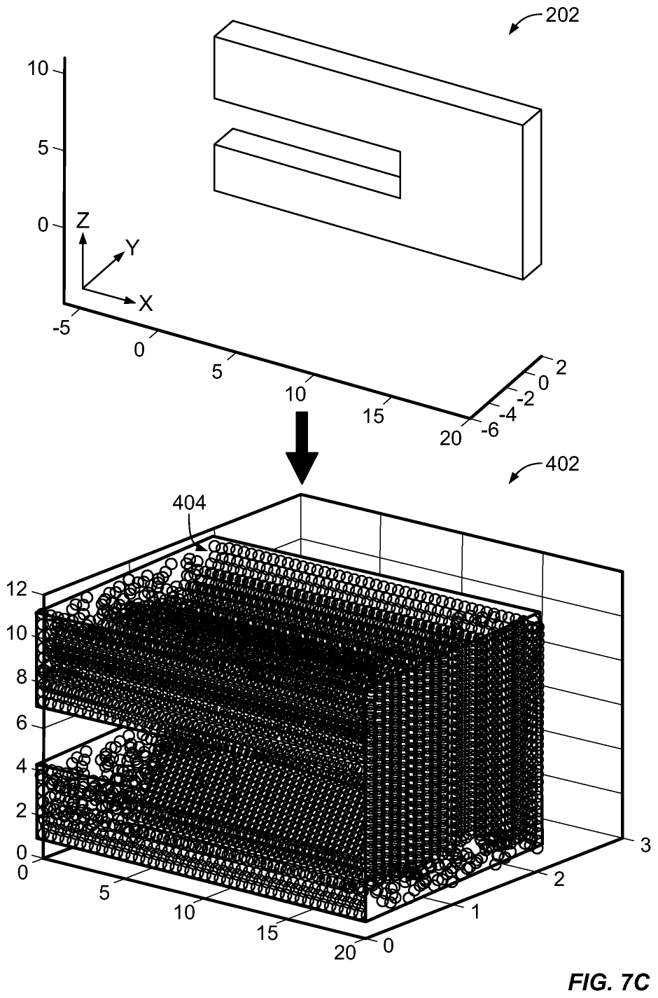

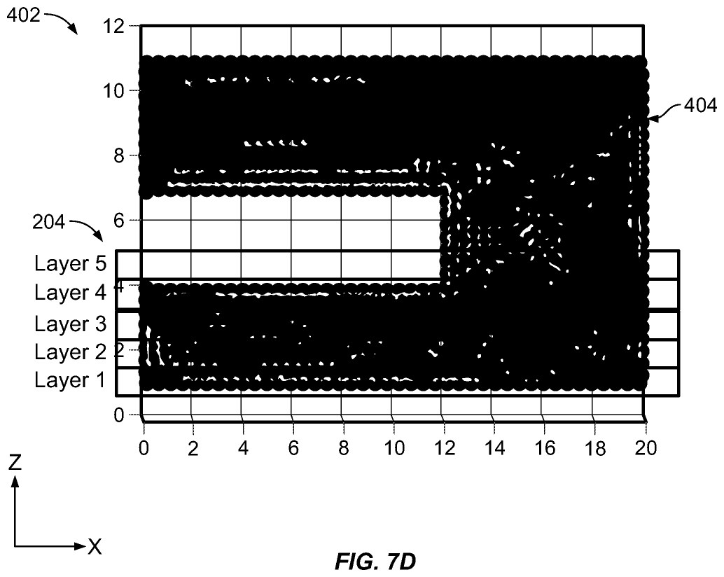

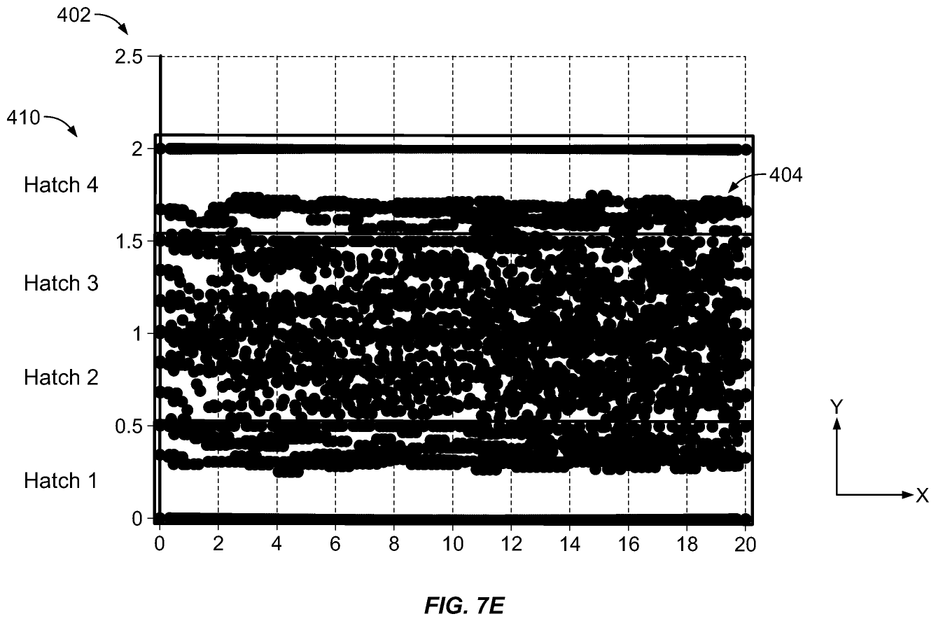

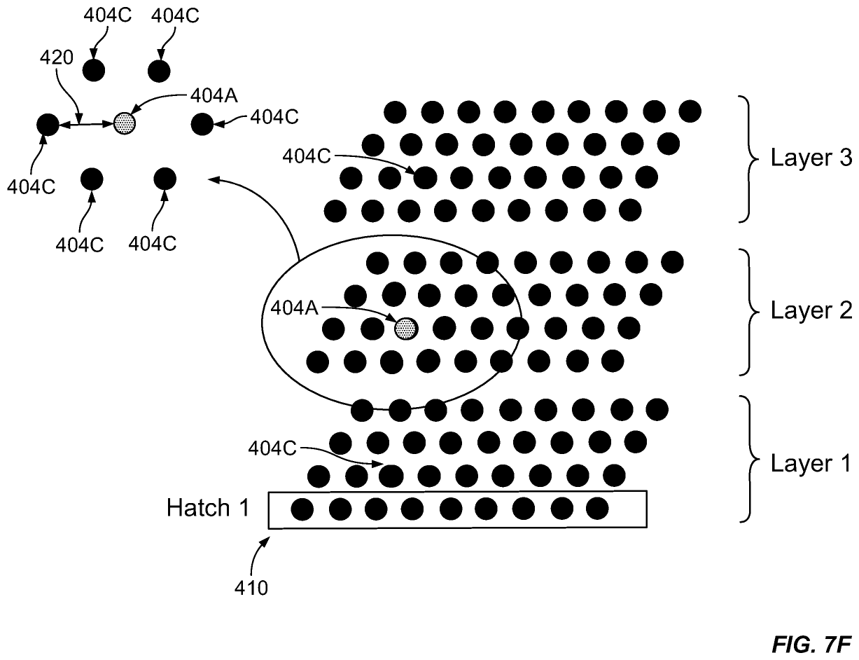

FIG. 7A depicts an example process 700 for modeling heat flux in AM parts made by a DED process. Process 700 can be executed in accordance with implementations of the present disclosure. The example process 700 can be implemented, for example, by one or more computing systems. Exemplary computing systems can include, but are not limited to, a super computer, a desktop computer, a laptop computer, or a tablet computer. In some examples, the example process 700 can be provided by one or more computer-executable programs executed using one or more computing devices. For example, the example process 700, or portions thereof, can be provided by one or more programs executed by a computing system. FIG. 7B illustrates graphical representations of the steps of process 700.

The computing system converts a three-dimensional model of an AM part into a node representation of the AM part (702). For example, a fixed number of spatial locations within the part are randomly sampled. The heat flux through the part is observed at these fixed spatial locations, termed nodes. In other words, the volume of the part to be simulated is randomly populated with nodes; the number of nodes is set at a certain number per unit volume (called node density). This discretization results in each node having a unique Cartesian (x, y, z) coordinate, i.e., the location of each node is spatially defined within the part. The random sampling of the nodes reduces the computational burden of the approach. The number of nodes is contingent on the geometry of the part. FIG. 7C depicts a graphical illustration of the conversion of a three-dimensional model of an AM part into a node representation.

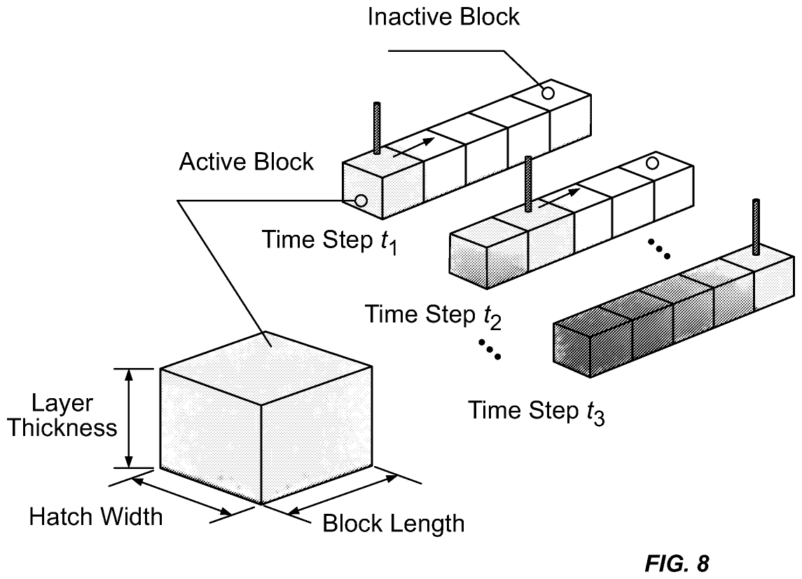

Next, each layer is divided into a hatch (in the case of a thin wall, each layer has only one hatch), and each hatch is further divided into discrete blocks (volumes) with a fixed height and length, with breadth equal to the hatch width. An example block is illustrated in FIG. 8. The computing system generates network graph of the AM part based on the node representation (704). Step 704 can include four sub-steps. The sub-steps can include: sorting nodes based on z-coordinates to define layers of the object (704a). FIG. 7D depicts a graphical representation of nodes being sorted into layers. Sorting nodes based on y-coordinates to define hatches (704b). FIG. 7E depicts a graphical representation of nodes being sorted into hatches. Sorting nodes based on X-coordinates to define blocks (704c). FIG. 8 depicts a graphical representation of nodes being sorted into blocks. In some implementations, the hatch and block widths and lengths are related to the size of a DED nozzle being simulated. For instance, the width of the hatch and block is comparable to the size of DED layer printed by a particular type or size nozzle. In some implementations, block lengths can be related to both nozzle size and the velocity at which the simulated nozzle is moved (or expected to be moved) across a part. For example, block length can be determined based on the nozzle velocity and a predetermined time step size. In such implementations, the block length would be the product of the nozzle velocity and the size of the time step.

For the example described herein, the single track or hatch that composes each deposited layer will be broken up into five equal blocks. These discrete blocks are 7.84 mm long, 3 mm wide, and 0.1806 mm thick. There are a total of 2830 blocks in the part (see e.g., FIGS. 7B-7E). The reason for dividing a hatch into blocks is explained in the context of Steps 706-708 and depicted in FIG. 8. Since the nodes are populated in a random manner, there is a degree of uncertainty in the model predictions. This uncertainty can be quantified by repeating the simulations three times for each case.

The system builds an network graph based on relationships between the nodes (704d). For example, FIG. 7F depicts a graphical representation of generating a weight for a node of an network graph based on neighbouring nodes. In more detail, the computing system calculates a graph over the set of nodes sampled in Step 702. Each node is connected to its nearest neighboring nodes within a ε-radius. Consider ε [mm] as describing the radius of a sphere around a node at the center of the sphere. Nodes that fall within the volume of the sphere are connected to the node at the center of the sphere. Nodes that are outside of the sphere are not connected. This step is completed throughout the entire cloud of nodes, which results in a complex web of connections called a network graph.

Consider two nodes, πᵢ and πⱼ, whose spatial Cartesian coordinates are cᵢ≡(xᵢ, yᵢ, zᵢ) and cⱼ ≡(xⱼ, yⱼ, zⱼ), respectively; πᵢ and πⱼ are connected by an edge having weight aᵢⱼ if the distance between them is less than ε,

$${a}_{i j} = \{ \begin{matrix}{e}^{- {( {c}_{i} - {c}_{j} )}^{2} / {σ}^{2}} & if {( {c}_{i} - {c}_{j} )}^{2} \leq ε \\ 0 & otherwise\end{matrix} \qquad ( 1 )$$

In Eqn. (1), σ is the standard deviation of all the pairwise distances between nodes, and the exponential term is the Gaussian function that scales the distance between the nodes in the part between 0 and 1. Nodes that are farther away from each other have an edge with a smaller weight connecting each other; nodes closer to each other are connected with an edge with a larger weight,

$${lim}_{( {c}_{i} - {c}_{j} ) \to 0} {a}_{i j} = 1 \qquad ( 2 )$$

$${lim}_{( {c}_{i} - {c}_{j} ) \to ε} {a}_{i j} = 0$$

The neighborhood distance ε is a heuristic tunable parameter in the graph theory model, that needs to be calibrated for different material types. The calibration procedure for ε is described in below.

The matrix formed by placing aᵢⱼ in a row i and column j is called the network graph, A=[aᵢⱼ], which is a positive symmetric matrix. From the network graph, the degree hᵢ of a node πᵢ is calculated by summing the corresponding i^{th} row (or column) of A, hᵢ=Σ_{∇j}aᵢⱼ. The graph Laplacian at node πᵢ is defined as: lᵢⱼ [symbol] hᵢ−aᵢⱼ, and the Laplacian matrix is obtained L=[lᵢⱼ]. Finally, the eigenspectra of the graph Laplacian matrix (L) will be computed as Lφ=φΛ, where φ are the eigenvectors and Λ are the eigenvalues of L.

The fusion of each layer is simulated block-by-lock by applying simulated heat to a layer of the AM part as represented by the network graph (706). For example, the DED simulation proceeds by heating the nodes in a block, before proceeding to the nodes in the next block. In other words, a time step involves heating of nodes inside a block, one block at a time. FIG. 8 demonstrates the block-by-block heating scheme. In the depicted example, the laser scan velocity is 8.5 mm·s⁻¹ and the length of each block is 7.84 mm long, the time to step between blocks is 0.922 s.

The diffusion of heat to other layers of the AM part as represented by the network graph is estimated (708). After a block is heated by the laser, the heat diffusion is simulated through the network graph that was constructed in step 704. For example, the heat diffusion between nodes is simulated based on the edge weight values connecting node pairs. Conduction is the sole mode of heat transfer between the nodes. The only nodes active during this step are the ones located within layers and blocks that have already been deposited. Other nodes that are in subsequent blocks and layers remain inactive and therefore unable to transfer heat. After the heat diffuses from the block that had just been heated by the laser, the deposition of the next block is simulated. This process is repeated for every block and every layer in the part. The mathematical implications of the approach will be summarized here by only including the final derived equation, shown in Eqn. (3).

After time step t_{b} (e.g., 0.922 s), viz, the time required to process each block, the temperature of each active node is contained in the temperature matrix T_{b}. The time step t_{b} in the simulation is not fixed but can vary depending on the laser speed and chosen block size. The temperature following heat transfer by conduction (T_{c}) is defined as a function of the Laplacian eigenvectors (φ) and eigenvalues (Λ) of the network graph over active nodes, where T₀ is the melt pool temperature, and g is a tunable parameter called the gain factor (g). The gain factor (g) scales the rate of thermal diffusivity or heat flux between nodes. A higher gain factor increases the rate of thermal diffusion through the part, i.e., the larger the gain factor, the faster the heat will dissipate through the part by conduction. The procedure to calibrate the gain factor is reported in below.

$${T}_{c} = ϕ {e}^{- α g Λ {t}_{b}} {ϕ}^{′} {T}_{0} \qquad ( 3 )$$

The calibration process involves comparison of the simulated temperature found by Eq. (3) with a test solution or test experiment.

The heat lost to the atmosphere is estimated (708). Heat transfer by conduction between the nodes is followed in tandem with heat loss through forced and free convection from the nodes on the surface of the part. The temperature distribution after heat loss through forced and free convection, and through clamp conduction takes place for the duration of the time t_{b}, and is obtained as,

$${T}_{b} = {T}_{c} {e}^{- β {t}_{b}} \qquad ( 4 )$$

$$β = \frac{h}{ρ \times L \times {c}_{p}}$$

Where h [W·m⁻²·K⁻¹] is the heat transfer coefficient, ρ is the material density [kg·m⁻³], and L (e.g., 7.84 mm) is the length of the block, and Cₚ is the specific heat [J·kg⁻¹° C.⁻¹] which is not a constant, but temperature-dependent. The derived coefficient, β, is called the inverse time constant [s⁻¹]. The heat transfer coefficient h has two parts, to include both free and forced convection. Heat loss due to forced convection is applied to the sides of the part and top of the substrate, as the carrier argon gas flows over these surfaces. Free convection is dominant on the sides and bottom of the substrate, where there is no active gas flow. The heat transfer coefficients are discussed in depth in below. There can be a different value of inverse time constant β for each node. Generally, β=0 at interior nodes and β≠0 at boundary nodes.

In steps 708 and 710, for simplicity, we described the heating of only those blocks in the topmost layer. However, in DED the block immediately below the block being heated is also at an elevated temperature as the laser penetrates deeper.

For each block-by-block iteration of steps 708 and 710, the temperature of every node is recorded in a vector T_{b}. This is repeated until an entire layer is simulated. After the process reaches the end of the layer, the system simulates heat dissipation by conduction and by convection in steps of, e.g., 1 second, iteratively for a period equal to the dwell time (t_{d}). Here, t_{d}=20 s for Case A, and t_{d}=3 s for Case B and Case C. In Eqns. (5) and (6) the time t=1 s, and therefore the pair of equations are looped together for 20 times for Case A, and 3 times for Cases B and C to simulate the total dwell time between layers.

$${T}_{L c} = ϕ {e}^{- α g Λ {t}_{d}} {ϕ}^{′} {T}_{b} \qquad ( 5 )$$

$${T}_{Lf} = {T}_{L c} {e}^{- β {t}_{d}} \qquad ( 6 )$$

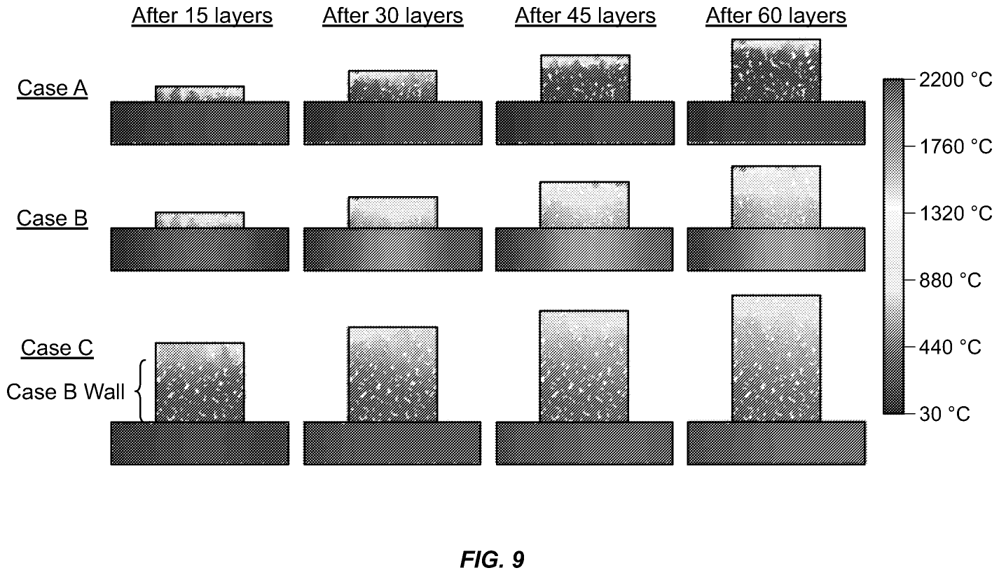

Steps 706 through 710 are repeated until heating and heat diffusion have been simulated on each layer of nodes (712). For example, steps 706 through 710 are looped until the last layer is built. The temperature of each node at each time step is recorded in a vector T, which contains the thermal history of the part. Then, a representation of the estimated heat distribution within the AM part is output (714). For example, the computing system can generate a three-dimensional heat map of the estimated heat flux within the AM part, e.g., such as those depicted in FIG. 9.

Improved Simulation Procedures using Discrete Green's Function

The above described process 700 can be improved upon by using discrete Green's functions through treatment of a generalized boundary condition.

Boundary heat loss is directly incorporated into the spectral graph (SG) method. Previously the SG method directly treated only insulated (type 2) boundaries, and boundary heat loss was included by a separate procedure, external to the spectral graph method (step 708), through which the precision of the heat loss was controlled by using multiple small timesteps. The improved SG method embodies a generalized boundary condition that provides for heat loss of any desired level which is equally precise for any time step size. This improves the computational efficiency of the SG method.

The SG method 700 is expanded to treat additional ways to add heat to the simulation (step 706). The previous SG method could only simulate heat added at the initial condition. Using the improved SG method, a discrete Green's function (GF) is defined, which allows for heat addition: from spatial variation of the initial condition (as previously); from time and space variation of volume heating (i.e. heat introduced inside the body as by chemical/nuclear reaction, electric resistance heating, laser absorption, etc.); and, from time and space variation of heating at boundaries of type 1 (specified temperature), type 2 (specified heat flow) or type 3 (specified convective condition).

The SG method is improved with weight factors based on the physics of heat flow (step 704d). The previous SG method contained weight factors which were drawn from an image-processing application, consequently calibration of two parameters is required to obtain quantitatively correct results. The new weight factors, based on the physics of heat flow between nodes, reduces the number of calibration factors from two to one, thereby simplifying the calibration process, and making the method easier to use.

### Theory and Development

### 2.1 Discrete Green's Function (Improvements to Step 706)

In the continuous Green's function (GF) method, the boundary value problem for temperature is recast into an integral expression containing the GF multiplied by each of the heating effects present in the problem, such as the initial condition, the internal heating function, and any boundary heating functions. The GF method is flexible and powerful because one GF allows for a large family of solutions to be treated in a straight-forward manner. In this section, the discrete GF approach is presented by analogy with the continuous GF method. The starting point is the boundary value problem for temperature:

$$\begin{matrix}\frac{1}{α} \frac{\partial T}{\partial t} = {∇}^{2} T + \frac{1}{k} g ( r , t ) & ( domain R )\end{matrix} \qquad ( 7 )$$

$$\begin{matrix}k \frac{\partial T}{\partial {n}_{m}} + {h}_{m} T = {h}_{m} {T}_{∞ m} + {q}_{m} & ( {m}^{t h} boundary of R )\end{matrix} \qquad ( 8 )$$

$$\begin{matrix}T ( r , t = 0 ) = {T}_{0} ( r ) & ( initial condition\end{matrix} ) \qquad ( 9 )$$

Here nₘ represents the outward normal vector on the m^{th} portion of the body surface, each of which is characterized by convection coefficient hₘ [Wm⁻²K⁻¹] and local ambient temperature T_{∞m}. Material properties are conductivity k [W^{m-1}K⁻¹] and diffusivity α [m²S⁻¹]. This problem will be made dimensionless with the following variables:

$$\tilde{T} = \frac{T - {T}_{∞}}{{T}_{1} - T ∞} ; \tilde{t} = \frac{at}{{L}^{2}} ; \tilde{r} = \frac{r}{L} ; {\tilde{n}}_{m} = \frac{{n}_{m}}{L} ; {B}_{m} = \frac{{h}_{m} L}{k} \qquad ( 10 )$$

$${\tilde{q}}_{m} = \frac{{q}_{m} L}{k {T}_{1}} ; \tilde{g} = \frac{{gL}^{2}}{{kT}_{1}}$$

Here L [m] is a length scale and T₁ [K] is a temperature scale. Introduce the above variables for the normalized temperature problem:

$$\begin{matrix}\frac{\partial \tilde{T}}{\partial t} = {\tilde{∇}}^{2} \tilde{T} + \tilde{g} ( \tilde{r} , \tilde{t} ) & ( domain R )\end{matrix} \qquad ( 11 )$$

$$\begin{matrix}\frac{\partial \tilde{T}}{\partial {\tilde{n}}_{m}} + {B}_{m} \tilde{T} = {B}_{n} {\tilde{T}}_{∞ m} + {\tilde{q}}_{m} & ( {m}^{t h} boundary of R )\end{matrix} \qquad ( 12 )$$

$$\begin{matrix}\tilde{T} ( \tilde{r} , \tilde{t} = 0 ) = {\tilde{T}}_{0} ( \tilde{r} ) & ( initial condition )\end{matrix} \qquad ( 13 )$$

The temperature is driven by three causative functions: internal heating \tilde{g}; initial condition \tilde{T}₀; and, boundary heating (BₘT_{∞m}+\tilde{q}ₘ). (e.g., improvements to Step 706). Here the boundary heating is a generalized condition which provides for three types of boundary heating conditions depending on the values of parameters Bₘ and \tilde{q}ₘ For nonhomogeneous type 3 boundary, take 0<Bₘ<∞ and qₘ=0. For boundary heating of type 2, take Bₘ=0 and qₘ≠0. For the nonhomogeneous type 1 boundary, divide Eq. (12) by Bₘ and take the limit as Bₘ→∞, as follows:

$$\begin{matrix}{\underbrace{\frac{1}{{B}_{m}} \frac{\partial \tilde{T}}{\partial {\tilde{n}}_{m}}}}_{= 0} + \tilde{T} = {T}_{∞ m} + {\underbrace{\frac{{\tilde{q}}_{m}}{{B}_{m}}}}_{= 0} & ( {m}^{t h} boundary of R )\end{matrix} \qquad ( 14 )$$

This is a nonhomogeneous type 1 condition on the m^{th} boundary.

Because the boundary value problem for temperature is linear, the GF method solution for the temperature is the sum of three terms:

$$\tilde{T} ( r , t ) = {\tilde{T}}_{i n} ( r , t ) + {\tilde{T}}_{g} ( r , t ) + {\tilde{T}}_{b c} ( r , t ) \qquad ( 15 )$$

Quantity \tilde{T}ᵢₙ is the temperature contribution from the initial condition, \tilde{T}_{g} is from internal (volumetric) heating, and \tilde{T}_{bc} is from the nonhomogeneous boundary conditions. In Table 1 the expression for each of these three terms is given for the analytical GF solution and by analogy, for the discrete GF solution. The entries in Table 1 will be discussed one at a time.

TABLE 1
Temperature expressions with the continuous GF and with the discrete
GF, with contributions to temperature caused by: initial condition \tilde{T}ᵢₙ;
internal heating \tilde{T}_{g}; and, boundary conditions \tilde{T}_{bc}.

| | Continuous GF | Discrete GF |
|---|---|---|
| \tilde{T}ᵢₙ | ∫_{R}G\|_{τ=0}\tilde{T}₀(r′) dv¹ | G\|ᵣ₌₀\tilde{T}₀ |
| \tilde{T}_{g} | ${\int }_{τ = 0}^{t} {\int }_{R} G \tilde{g} ( {r}^{′} , τ ) {dv}^{′} d τ$ | ${\int }_{0}^{t} G \tilde{g} d τ$ |
| \tilde{T}_{bc} | ${\int }_{τ = 0}^{t} {\int }_{{A}_{m}} G {\vert}_{{r}^{′} m} ( {B}_{m} {\tilde{T}}_{∞ m} + {\tilde{q}}_{m} ) {{dA}^{′}}_{m} d τ$ | ${\int }_{0}^{t} G {\tilde{g}}_{m} d τ , where$ |
| | | ${\tilde{g}}_{m} = ( {B}_{m} {\tilde{T}}_{∞ m} + {\tilde{q}}_{m} ) \frac{{\tilde{A}}_{m}}{{\tilde{V}}_{m}}$ |

The first row of Table 1 shows the contribution to temperature from a non-zero initial condition. To discern the discrete temperature expression from the continuous temperature expression, the spatial integral in the continuous temperature expression is replaced by the discrete GF matrix multiplied by the initial temperature vector \tilde{T}₀. This matrix multiplication insures that all nodes with non-zero initial condition have an impact on the resulting temperature.

The second row of Table 1 gives the contribution to the temperature caused by internal heat generation, and as for the first row, the spatial integral from the continuous temperature expression is replaced by the GF matrix multiplied by the causative effect, this time the internal heating vector \tilde{g} to produce the discrete temperature expression. Vector \tilde{g} may vary in space and in time.

The third row of Table 1 gives the contribution to temperature for heating at the boundary. For the continuous GF method, there is a surface integral involving the GF evaluated at the boundary \tilde{r}′=\tilde{r}ₘ′, multiplied by the boundary heat flux (Bₘ,\tilde{T}_{∞m}+\tilde{q}ₘ). This surface integral is developed from a volume integral using Green's theorem. In contrast, the discrete GF can only be evaluated at node locations, which may or not be located at the boundary. To construct the discrete temperature expression for boundary heating, the surface integral from the continuous temperature expression is replaced by the GF matrix multiplied by an n-vector \tilde{g}ₘ whose elements are non-zero only at boundary nodes where heating takes place. The elements of vector \tilde{g}ₘ are given by:

$${\tilde{g}}_{m} \{ \begin{matrix}( {B}_{m} {\tilde{T}}_{∞ m} + {\tilde{q}}_{m} ) {\tilde{A}}_{m} / {\tilde{V}}_{m} ; & node m on boundary \\ 0 ; & otherwise\end{matrix} \qquad ( 16 )$$

which represent the equivalent volumetric heating caused by heating at boundary nodes. That quantity \tilde{g}ₘ should contain the ratio Aₘ/Vₘ can be demonstrated by equating the energy added to a node by volume generation g to that added by boundary heat flux q:

$$g \cdot V = q \cdot A , or , g = q \cdot \frac{A}{V} \qquad ( 17 )$$

This energy balance states that the equivalent volumetric generation [W m⁻³] is equal to the applied heat flux [W m⁻²] times area [m²] divided by nodal volume [m³].

The use of the GF provides a comprehensive and systematic approach for a family of solutions for a variety of heating conditions, once the GF is known. In the following section, the discrete GF is developed from the spectral graph method.

### 2.2 Spectral Graph Method for the Discrete Green's Function

The Green's function will be found as the solution to an initial-condition problem with homogeneous boundary conditions. However here the spectral graph method will be applied to the heat equation, by replacing the Laplacian operator (\tilde{∇}²) with a discrete operator called the Laplacian matrix (L). Also the continuous temperature is replaced by a vector of discrete temperatures (\tilde{T}) at node points in the domain. The discrete form of the heat diffusion equation, with homogeneous boundary conditions and specified initial condition, may be written as:

$$\begin{matrix}\frac{\partial {\tilde{T}}_{i n}}{\partial \tilde{t}} = - L {\tilde{T}}_{i n} & ( domain R )\end{matrix} \qquad ( 18 )$$

$$\begin{matrix}\frac{\partial {\tilde{T}}_{i n}}{\partial {\tilde{n}}_{m}} + {B}_{m} {\tilde{T}}_{i n} = 0 & ( {m}^{t h} boundary of R )\end{matrix} \qquad ( 19 )$$

$$\begin{matrix}{\tilde{T}}_{i n} {\vert}_{\tilde{t} = 0} = {\tilde{T}}_{0} & ( initial condition )\end{matrix} \qquad ( 20 )$$

Note the sign change in Eq. (12), as the Laplacian matrix L from graph theory is defined with sign opposite to that of the continuous Laplacian operator (\tilde{∇}²). A contribution of the present work is the type 3 boundary condition in Eq. (13); although elements of the following development are similar to our previous work with the type 2 (insulated) boundary, the present analysis goes further to define the discrete Green's function. For the moment we assume that the Laplacian matrix satisfies the type 3 boundary condition; internal details of this Laplacian matrix are developed later in Section 2.3.

The next step is to solve an eigenvalue problem using standard matrix methods. Laplacian matrix L satisfies the following eigenvalue equation:

$$L ∅ = ∅ Λ \qquad ( 21 )$$

where Ø is the orthogonal eigenvector matrix, Λ is the diagonal eigenvalue matrix. The eigenvector matrix φ is orthogonal because L is symmetric and diagonally dominant. Since for an orthogonal matrix the transpose is equal to its inverse, the product of the eigenvector matrix and its transpose is the identity matrix. That is:

$$∅ {∅}^{′} = ∅ {∅}^{- 1} \qquad ( 22 )$$

Using this property, post-multiply the eigenvalue equation, Eq. (21), by the matrix Ø′:

$$L ∅ {∅}^{′} = ∅ Λ {∅}^{′} \qquad ( 23 )$$

$$LI = ∅Λ {∅}^{′}$$

$$L = ∅Λ {∅}^{′}$$

Replace this result into the discrete diffusion equation, Eq. (18):

$$\frac{\partial {\tilde{T}}_{in}}{\partial \tilde{t}} = - ( {∅Λ∅}^{′} ) {\tilde{T}}_{i n} \qquad ( 24 )$$

This above equation is a first order matrix differential equation whose solution has the form of a matrix exponential:

$${\tilde{T}}_{i n} = {e}^{- ∅ Λ {∅}^{′ \tilde{t}}} {\tilde{T}}_{0} \qquad ( 25 )$$

Recall that \tilde{T}₀ is the initial temperature vector. Next the exponential in the above solution will be expanded using a Taylor series. The exponential of matrix u is given by

$${e}^{- u} = I - \frac{u}{1 !} + \frac{{u}^{2}}{2 !} - \frac{{u}^{3}}{3 !} + … \qquad ( 25.1 )$$

Apply the above Taylor series expansion to the exponential term from Eq. (25), and simplify:

$$\begin{matrix}{e}^{- ∅ Λ {∅}^{′ \tilde{t}}} = I - \tilde{t} \frac{- {∅Λ∅}^{′}}{1 !} + {\tilde{t}}^{2} \frac{{( ∅ Λ ∅ ′ )}^{2}}{2 !} - {\tilde{t}}^{3} \frac{{( {∅Λ∅}^{′} )}^{3}}{3 !} + … \\ = I - \tilde{t} \frac{- ∅ Λ {∅}^{′}}{1 !} + {\tilde{l}}^{2} \frac{( ∅ Λ {∅}^{′} ) ( ∅ Λ {∅}^{′} )}{2 !} - \\ {\tilde{t}}^{3} \frac{( ∅ Λ {∅}^{′} ) ( ∅ Λ {∅}^{′} ) ( ∅ Λ {∅}^{′} )}{3 !} + … \\ = I - \frac{∅ ( Λ \tilde{t} ) {∅}^{′}}{1 !} + \frac{{∅ ( Λ \tilde{t} )}^{2} {∅}^{′} )}{2 !} - \frac{( {∅ ( Λ \tilde{t} )}^{3} {∅}^{′} )}{3 !} + … \\ = ∅ [ I - \frac{Λ \tilde{t}}{1 !} + \frac{{( Λ \tilde{t} )}^{2}}{2 !} - \frac{{( Λ \tilde{t} )}^{3}}{3 !} + … ] {∅}^{′} \\ = ∅ [ {e}^{- Λ t} ] {∅}^{′}\end{matrix} \qquad ( 26 )$$

The final exponential argument contains only the eigenvalue matrix multiplied by time. With this simplification the temperature solution (Eq. 25) is given by

$${\tilde{T}}_{in} = ∅ {e}^{- Λ \tilde{t}} {∅}^{′} {\tilde{T}}_{0} \qquad ( 27 )$$

In this solution, the spatial behavior is embodied in the eigenfunction matrix φ and the time-evolution behavior is embodied in the eigenvalue matrix Λ. At small values of time, many eigenvalues within the matrix exponential e^{-Λ\tilde{t}} contribute to the temperature distribution. At large values of time, however, the temperature depends only on the smallest non-zero eigenvalue (also called the Fiedler eigenvalue), which determines the rate at which the temperature decays toward the final (steady) value. This is analogous to the effect of time on the number of series terms needed from a Fourier-series solution of the continuum heat diffusion equation.

Next the above solution is compared to that from the GF approach. Assuming for the moment that the GF is known, the solution to the discrete initial-temperature problem (Eq. 18-20) is constructed by multiplying the GF by the initial temperature \tilde{T}₀ as given in the first row of Table 1:

$${\tilde{T}}_{in} = G {\vert}_{r = 0} {\tilde{T}}_{0} \qquad ( 28 )$$

Here G|ᵣ₌₀ is the discrete GF evaluated at heating time τ=0. Now compare the formal statement of the discrete GF solution in Eq. (28) to the spectral graph solution given in Eq. (27). As the solution to a boundary value problem is unique, the discrete GF evaluated at τ=0 must be:

$$G {\vert}_{r = 0} \vert = ∅ {e}^{- Λ {t}^{\sim ′}} \qquad ( 29 )$$

The final step is to recognize that the time behavior of every GF for the heat equation has functional form (t−τ) where t is the observation time and τ is the heating time. Then the discrete GF for τ/=0 is given by:

$$G = ∅ {e}^{- Λ ( \tilde{t} - \tilde{r} )} {∅}^{′} \qquad ( 30 )$$

This is the discrete GF in the form of a matrix, as provided by the spectral graph (SG) method, an improvement to the heating step 706. The discrete GF satisfies a (discrete) boundary value problem with homogeneous boundary conditions and impulsive initial condition. One column of the GF matrix contains the temperature response to a unit-impulse initial condition at one node; all the columns together provide the comprehensive response.

The above GF matrix was developed assuming that the Laplacian matrix is known, has well-behaved eigenvectors and eigenvalues, and satisfies type 3 boundary conditions that are homogeneous. In the next section the details of the Laplacian matrix are developed.

### 2.3 Energy Balance for a Node at a Convection Boundary (e.g., Improvements to Step 708)

In this section the required Laplacian matrix is constructed from the node equations for the discrete form of the heat conduction. The node equations are found from an energy balance using the finite-volume theory. A node at the boundary is examined with convection heat loss, and then the result for a non-boundary (interior) node is a straightforward special case.

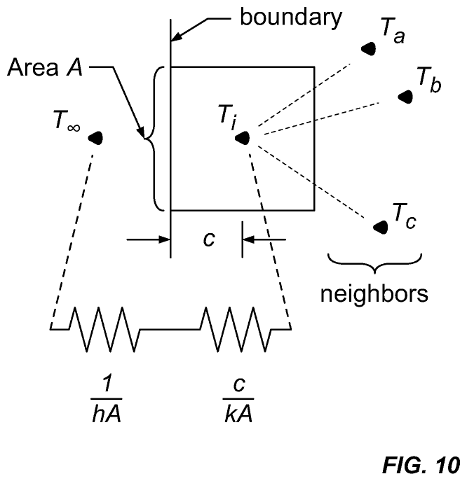

The discussion begins with the energy balance on the element containing node i at temperature Tᵢ shown in FIG. 10. The sum of the heat flow into element i is equal to the energy storage in the element:

$$\sum Q = {CV}_{i} \frac{\partial {T}_{i}}{\partial T} \qquad ( 31 )$$

Here Q [W] is heat flow into the element, C is volumetric specific heat [Jm⁻³ K], Vᵢ is element volume [m³], and t is time [s]. The energy storage is proportional to the time-rate-of-change of temperature in the element, Tᵢ. The heat flow may come from neighbor nodes or it may come through the boundary. The heat flow coming from the jth neighbor node is given by:

$${Q}_{j = {w}_{ij}} ( {T}_{j} - {T}_{i} ) \qquad ( 32 )$$

Where
Tᵢ . . . temperature of node i of interest [K]
Tⱼ . . . temperature of neighbor node j [K]
Wᵢⱼ . . . edge weight between nodes i and j [W K⁻¹]
   It is important to note that edge weights are non-zero only for near-neighbor nodes, and they depend only on the distance between nodes. More information on edge weights is given later in Section 2.4.

The heat flow from the boundary into node i is found from the thermal resistance:

$$Q = \frac{{T}_{∞} - {T}_{i}}{{R}_{i}} \qquad ( 33 )$$

Where
T_{∞} . . . ambient temperature [K]
Rᵢ . . . total thermal resistance at boundary [K W⁻¹]
   The thermal resistance is the sum of two thermal resistors, shown in FIG. 1:

$${R}_{i} = \frac{1}{{h}_{i} {A}_{i}} + \frac{{c}_{i}}{{kA}_{i}} \qquad ( 34 )$$

where hᵢ is the heat transfer coefficient [Wm⁻²K⁻¹], Aᵢ is the area for boundary heat transfer [m²], cᵢ [m] is distance from node i to the boundary as shown in FIG. 1, and k is thermal conductivity [W^{m-1}K⁻¹]. Heat transfer coefficient hᵢ is an effective value that includes both convective and radiative contributions. Replace the two types of heat flow into Eq. (31) to find the boundary node heat balance:

$${\sum }_{j = 1}^{n} {w}_{ij} ( {T}_{j} - {T}_{i} ) + \frac{{T}_{∞} - {T}_{i}}{{R}_{i}} = {CV}_{i} \frac{\partial {T}_{i}}{\partial T} \qquad ( 35 )$$

where n is the number of nodes in the body. Although the sum in the above expression is shown over all the nodes in the body, weights wᵢⱼ are non-zero only for near-neighbor nodes.

### 2.3.1 Normalized Energy Balance

The node equation will be normalized with the following dimensionless variables:

$$\tilde{T} = \frac{T - {T}_{∞}}{{T}_{1} - {T}_{∞}} ; \tilde{t} = \frac{kt}{{CL}^{2}} ; {\tilde{w}}_{ij} = \frac{{w}_{ij} {L}^{2}}{{kV}_{i}} \qquad ( 36 )$$

$$\tilde{A} = \frac{{A}_{i}}{{L}^{2}} ; {\tilde{V}}_{i} = \frac{{V}_{i}}{{L}^{3}} ; \tilde{{c}_{ι}} = \frac{{c}_{i}}{L} ; {B}_{i} = \frac{{h}_{i} L}{k}$$

where T₁ is a characteristic temperature [K] and L is a characteristic global length [m], and Bᵢ is the Biot number describing heat loss at the boundary. Replace these dimensionless variables into Eq. (31), use the definition of resistance Rᵢ from Eq. (34), and after some algebra, the boundary node heat balance takes the form.

$${\sum }_{j = 1}^{n} {\tilde{w}}_{ij} ( {\tilde{T}}_{j} - {\tilde{T}}_{i} ) - {\tilde{E}}_{i} {\tilde{T}}_{i} = \frac{\partial {\tilde{T}}_{ι}}{\partial \tilde{t}} \qquad ( 37 )$$

$$where {\tilde{E}}_{i} = \frac{\tilde{{A}_{ι}}}{{\tilde{V}}_{i}} ( \frac{{B}_{i}}{1 + \tilde{{B}_{ι}} {c}_{i}} ) \qquad ( 38 )$$

Here Eᵢ is a dimensionless conductance for heat loss when node i is located at a type 3 boundary. Note the sign change on this boundary term, which comes from the definition of the normalized temperature. Finally, separate those terms involving neighbor temperatures from the temperature at the ith node:

$${\underbrace{{\sum }_{j = 1}^{n} {\tilde{w}}_{ij} {\tilde{T}}_{j}}}_{off Diagonal} - {\underbrace{{\sum }_{j = 1}^{n} {\tilde{w}}_{ij} {\tilde{T}}_{i} - {\tilde{E}}_{i} {\tilde{T}}_{i}}}_{Diagonal} -= \frac{\partial {\tilde{T}}_{i}}{\partial \tilde{t}} \qquad ( 39 )$$

In the above expression the labels ‘diagonal’ and ‘off diagonal’ identify the locations of these terms in the ith row of the Laplacian matrix when the ith node is at a type 3 boundary. For non-boundary nodes, or for nodes on insulated boundaries, the development is identical, except that there is no external heat flow. That is, set Eᵢ=0 at interior nodes, then the heat balance is given by:

$${\underbrace{{\sum }_{j = 1}^{n} {\tilde{w}}_{ij} {\tilde{T}}_{j}}}_{off diagonal} - {\underbrace{{\sum }_{j = 1}^{n} {\tilde{w}}_{ij} {\tilde{T}}_{j}}}_{diagonal} = \frac{\partial {\tilde{T}}_{i}}{\partial \tilde{t}} ( interior node ) \qquad ( 40 )$$

### 2.3.2 Details of the Laplacian Matrix

In this section the Laplacian matrix is assembled from the energy balance relations at each node. The Laplacian matrix is the discrete matrix that replaces the spatial derivatives when the continuous heat equation is replaced by the discrete heat equation. The discrete heat equation is given by Eq. (28):

$$- L \tilde{T} = \frac{\partial \tilde{T}}{\partial \tilde{t}} \qquad ( 41 )$$

Recall that L is the Laplacian matrix and T is the (dimensionless) temperature vector. Next write out the full matrix form of the above energy equation, as follows:

$$- [ \begin{matrix}{L}_{11} & {L}_{12} & ⋯ & {L}_{1 n} \\ {L}_{21} & {L}_{22} & ⋯ & {L}_{2 n} \\ ⋮ & & ⋱ & {L}_{n - 1 , n} \\ {L}_{n 1} & ⋯ & {L}_{n , n - 1} & {L}_{nn}\end{matrix} ] [ \begin{matrix}{\tilde{T}}_{1} \\ {\tilde{T}}_{2} \\ ⋮ \\ {\tilde{T}}_{n}\end{matrix} ] = \frac{\partial }{\partial \tilde{t}} [ \begin{matrix}{\tilde{T}}_{1} \\ {\tilde{T}}_{2} \\ ⋮ \\ {\tilde{T}}_{3}\end{matrix} ] \qquad ( 42 )$$

Next, consider the ith row of the above expression, and compare it to the node equations given earlier for boundary nodes (Eq. 39) and for interior nodes (Eq. 34). A careful examination shows that the elements of the Laplacian matrix have the following form:

$${L}_{ij} = \{ \begin{matrix}- {\tilde{w}}_{ij} ; & i \neq j \\ {\sum }_{j = 1}^{n} {\tilde{w}}_{ij} + {\tilde{E}}_{i} ; & i = j\end{matrix} \qquad ( 43 )$$

Recall that Eᵢ≠0 only for nodes located on a boundary exchanging heat with the surroundings.

The above Laplacian matrix was developed from an energy balance. The addition of the heat-loss term Eᵢ term at boundary nodes is a unique contribution of the present work; without this term the above development is equivalent to the usual graph theory approach involving an adjacency matrix and a diagonal matrix.

### 2.4 Physics-Based Edge Weights (e.g., Improvements to Step 704d)

Edge weights wᵢⱼ were defined earlier in Eq. (32) as Q=_{wij}(Tⱼ−Tj). The edge weight multiplies a temperature difference to give the heat flow. The edge weights developed here are consistent with the finite volume method. For heat transfer in a solid body, the heat flow rate from node j to node i is given by:

$$Q = \frac{{kA}_{ij}}{{d}_{ij}} ( {T}_{j} - {T}_{i} ) \qquad ( 44 )$$

The heat flow rate depends on the conductivity k [W m⁻¹ K⁻¹], the area for heat flow Aᵢⱼ [m²], and the distance between the nodes dᵢⱼ [m]. Then the edge weights are given by

$${w}_{ij} = \frac{{kA}_{ij}}{{d}_{ij}} or , {\tilde{w}}_{ij} = \frac{{\tilde{A}}_{ij}}{\tilde{d} {\tilde{V}}_{i}} \qquad ( 45 )$$

The normalized edge weight is constructed using the normalized variables in Eq. (10), where Vᵢ is the (normalized) small volume associated with node i. To fully specify the edge weight, geometric information on the nodal grid is required to determine ratio Aᵢⱼ/Vᵢ. Three grid geometries are discussed below.

### 2.4.1 1-D Uniform Grid

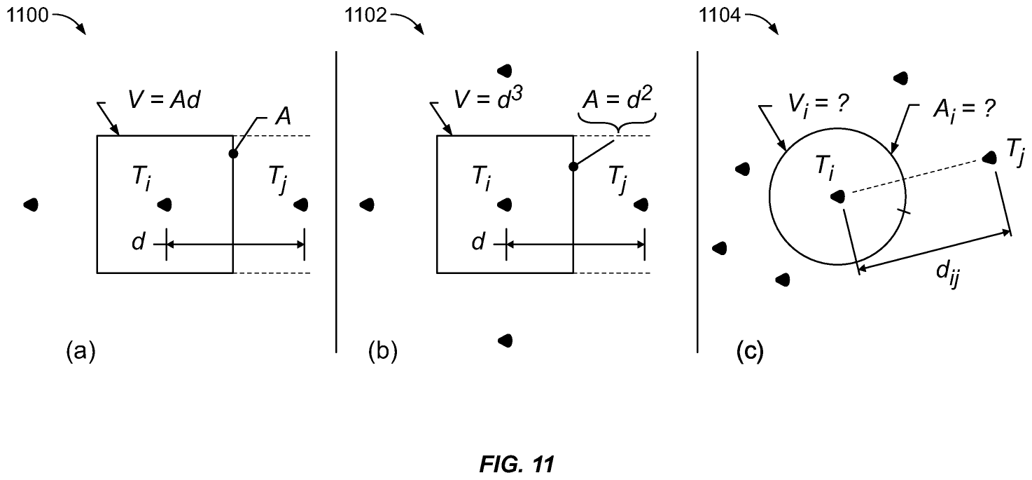

In the one-dimensional uniform grid, the node spacing and the heat transfer area is the same for every pair of adjacent nodes. Refer to FIG. 11 diagram 1100 for a schematic of the 1-D uniform grid. Let d be the (normalized) node spacing and let A be the (normalized) heat transfer area, so that the nodal volume is given by V=Ad. Then the edge weights are given by

$${\tilde{w}}_{ij} = \frac{{\tilde{A}}_{i}}{\tilde{d} {\tilde{A}}_{i} \tilde{d}} = \frac{1}{{\tilde{d}}^{2}} \qquad ( 46 )$$

These edge weights are identical to the temperature coefficients used in the finite difference method, which means that the one-dimensional SG method and the one-dimensional finite difference method have the same spatial behavior.

### 2.4.2 3D Uniform Rectangular Grid

In the 3-D unifanyorm rectangular grid shown in FIG. 11 diagram 1100, the node spacing and the heat transfer area is the same for every pair of adjacent nodes, and the volume associated with node i is a small cube. Let d be the (normalized) node spacing, let A=d² be the area for heat transfer, and let V=d³ be the nodal volume. Then the edge weights are given by:

$${\tilde{w}}_{ij} = \frac{{\tilde{d}}^{2}}{\tilde{d} {\tilde{d}}^{3}} = \frac{1}{{\tilde{d}}^{2}} \qquad ( 47 )$$

which are identical to the 1-D case.

### 2.4.3 3-D Random Grid

In the 3-D random grid shown in FIG. 11 diagram 1104, the edge weight depends upon the details of the geometric relationships among all of the nodes surrounding node i. In the spectral graph method, however, it is important that the edge weights depend primarily on the internodal distance, rather than on geometric details. In the authors' previous work, the edge weights for the 3-D random grid had an exponential form, drawn from image processing applications, as follows:

$${\tilde{w}}_{ij} = \{ \begin{matrix}f exp ( - \frac{{\tilde{d}}_{ij}^{2}}{{σ}^{2}} ) ; & {\tilde{d}}_{ij} < {r}_{n} \\ 0 ; & {\tilde{d}}_{ij} \geq {r}_{n} , and i = j\end{matrix} \qquad ( 48 )$$

Quantity σ is the standard deviation of all lengths \tilde{d}ᵢⱼ. Quantity f is the gain factor and rₙ is the neighbor radius, and these two quantities need to be chosen through a calibration process for the method to provide good results. This approach provided reasonable precision with very low computation cost for mesh generation.

In the present work, edge weights for the 3-D random grid were sought that are based on the physics of the problem yet were compatible with the spectral graph method. Edge weights were sought that would: depend on internodal distance \tilde{d}ᵢⱼ; build upon our experience with exponential weights used previously; avoid dependence on local ratio Ãᵢⱼ/\tilde{V}ᵢ; and; reduce to

$$1 / {\tilde{d}}_{ij}^{2}$$

in the limit as the random grid moves toward a uniform rectangular grid.

This last requirement suggested that a simple yardstick was needed to determine when a given grid deviates from the uniform rectangular grid. The average distance between adjacent nodes is defined

$$ℓ = {( \frac{{V}_{tot}}{n} )}^{1 / 3} . \qquad ( 49 )$$

Quantity l may be viewed as the width of a cube containing the average nodal volume; for a uniform rectangular grid l is the exactly the distance between nearest nodes. With quantity l, the following edge weights satisfy the above constraints:

$${\tilde{w}}_{ij} = \{ \begin{matrix}\frac{f}{{ℓ}^{2}} exp ( \frac{{ℓ}^{2} - {\tilde{d}}_{ij}^{2}}{{σ}^{2}} ) ; & {\tilde{d}}_{ij} < \sqrt{2 ℓ} \\ 0 ; & {\tilde{d}}_{ij} \geq \sqrt{2 ℓ} and i = j\end{matrix} \qquad ( 50 )$$

These physics-based edge weights have several important features. First, in the limit as distance dᵢⱼ approaches the average nodal distance [symbol] , the exponential becomes unity and the edge weight has functional form 1/ [symbol] ² which is in agreement with the energy-conserving finite volume formulation. Therefore this expression for the edge weights applies to every geometry. Second, radius [symbol] defines a sphere which provides a small number of nearest neighbors; this would be six neighbors for a uniform rectangular grid (for an interior node). In contrast, in previous work the nearest neighbors were defined by an independently-chosen neighbor radius. The present work has linked the neighbor radius to the number of nodes, thus reducing the number of calibration parameters from two to one which simplifies the calibration process. Third, because the edge weights are scaled by length f which depends on the number of nodes, the calibration may be carried out on one grid and the calibration does not have to be repeated if the node count is changed, for example, as part of a grid refinement study.

There is an alternate physics-based edge weight that may be employed in some implementations of the simulation. The alternate physics-based edge weight performs similarly to (44), and is:

$${\tilde{w}}_{ij} = \{ \begin{matrix}\frac{f}{ℓ {d}_{ij}} ; & {d}_{ij} < \sqrt{2 ℓ} \\ 0 ; & {d}_{ij} \geq \sqrt{2 ℓ} and i = j\end{matrix} \qquad ( 50.1 )$$

The alternate physics-based edge weight (50.1) has similar features to Eq. (50). First in the limit as distance dᵢⱼ approaches the average nodal distance [symbol] , the edge weight has functional form 1/ [symbol] ² which is in agreement with the energy-conserving finite volume formulation. The second and third features are identical to those described above in referenced to Eq. (50).

Quantity \tilde{E}ᵢ for boundary heat loss, defined in Eq. (38), must also be determined, which depends upon the nodal surface area for external heat loss Aₘ. Although the details of the body shape could be used to provide a precise surface area Am for each surface node, this is not consistent with the geometry-blind edge weights discussed above. Instead an average external surface area is used, the same for each boundary node, defined by the overall surface area of the body, divided by the number of surface nodes. This is congruent with the goal of the present work for rough and rapid thermal simulations, as distinct from FE solutions, which require burdensome meshing calculations. This approach is most accurate for bodies with high node counts and generous fillets, and the level of approximation increases as the node count decreases and the fillet radius decreases.

### 2.5 Discrete in Space, Analytic in Time

Through the discrete GF, the spectral graph method has been extended to provide for internal heating, with heating at the boundary treated as a special case of internal heating. The temperature expression for internal heating contains a time integral, which is discussed here to demonstrate that the spectral graph method is discrete in space and analytic in time.

Consider an internal heating function \tilde{g} which produces a temperature response described by the time integral given in Table 1. Into this time integral substitute the spectral graph form of the GF matrix given by Eq. (30), to find

$${\tilde{T}}_{g} ( \tilde{r} , \tilde{t} ) = {\int }_{r = 0}^{t} ∅ {e}^{- Λ ( \tilde{t} , \tilde{r} )} {∅}^{′} \tilde{g} d \tilde{T} \qquad ( 51 )$$

The ease or difficulty in evaluating this time integral depends on the time behavior of internal heating function \tilde{g}. In the special case of time invariant internal heating, then the time integral may be evaluated in closed form. Recall that the eigenvector matrix Ø is a function of space, not of time. Then eigenvector matrix Ø and its transpose may be removed from the time integral, and the time integral may be evaluated as follows:

$${\tilde{T}}_{g} ( \tilde{r} , \tilde{t} ) = ∅ [ {\int }_{r = 0}^{t} {e}^{- Λ ( \tilde{t} , \tilde{r} )} d \tilde{T} ] {∅}^{′} \tilde{g} = ∅ [ {Λ}^{- 1} ( I - {e}^{- Λ \tilde{t}} ) ] {∅}^{′} \tilde{g} = {∅Λ}^{- 1} {∅}^{′} \tilde{g} - {∅Λ}^{- 1} {e}^{- Λ \tilde{t}} {∅}^{′} \tilde{g} ; \tilde{g} \neq \tilde{g} ( \tilde{t} ) \qquad ( 52 )$$

Here the temperature expression is the sum of a steady part and a complementary transient part. Consequently, the above solution does not apply if the steady solution does not exist, for example, if all the boundaries are insulated (Neumann type). In this circumstance the smallest eigenvalue is zero so that the inverse of the eigenvalue matrix (Λ−1) does not exist. There are techniques for dealing with this zero-eigenvalue problem which will not be discussed here in the interest of brevity.
A closed-form solution may also be found for heating that is piecewise constant in time. Suppose the internal heating function varies in space and is on-off in time, given by:

$$\tilde{g} = \{ \begin{matrix}{\tilde{g}}_{0} ( \tilde{r} ) , & 0 < \tilde{t} \leq {\tilde{t}}_{1} \\ 0 , & \tilde{t} > {\tilde{t}}_{1}\end{matrix} \qquad ( 53 )$$

Replace this function into Eq. (51) and the integral may be evaluated to give a piecewise-in-time temperature response:

$$for \tilde{t} \leq {\tilde{t}}_{1} : \qquad ( 54 )$$

$${\tilde{T}}_{g} ( \tilde{r} , \tilde{t} ) = {∅Λ}^{- 1} ( I - {e}^{- Λ \tilde{t}} ) {∅}^{′} {\tilde{g}}_{0} ( \tilde{r} )$$

$$for \tilde{t} > {\tilde{t}}_{1} :$$

$${\tilde{T}}_{g} ( \tilde{r} , \tilde{t} ) = {∅Λ}^{- 1} ( {e}^{- Λ ( \tilde{t} - {\tilde{t}}_{1} )} - {e}^{- Λ \tilde{t}} ) {∅}^{′} {\tilde{g}}_{0} ( \tilde{r} )$$

This solution may be used as a building block to construct the response to any piecewise-in-time heating function, which has application for simulation of a variety of manufacturing processes such as laser welding.

### 3 Verification by Comparison with Exact Solutions

In this section examples are given for heat diffusion with plane surfaces for which exact analytical solutions are available, and the exact solutions are compared with numerical results from the improved spectral graph method. The first example is a slab body heated internally, the second example is a slab body with boundary heating of type 3, and the third example is a three dimensional body (parallelepiped) with non-zero initial conditions.

### 3.1 Example 1. Slab Body Heated Internally

Consider the following 1D problem with steady piecewise internal heating, one boundary insulated, and one boundary with convection heat loss:

$$\frac{\partial \tilde{T}}{\partial \tilde{t}} = \frac{{\partial }^{2} \tilde{T}}{\partial {\tilde{x}}^{2}} + \tilde{g} ( \tilde{x} ) \qquad ( 55 )$$

$$at \tilde{x} = 0 , \frac{\partial \tilde{T}}{\partial \tilde{x}} = 0$$

$$at \tilde{x} = 1 , k \frac{\partial \tilde{T}}{\partial \tilde{x}} + {B}_{2} \tilde{T} = 0$$

$$at \tilde{t} = 0 , \tilde{T} ( \tilde{x} , 0 ) = 0$$

$$and where \tilde{g} ( \tilde{x} ) = \{ \begin{matrix}1 ; & 0 < \tilde{x} \leq \tilde{a} \\ 0 ; & \tilde{x} > \tilde{a}\end{matrix} \qquad ( 56 )$$

This problem has been normalized with the variables given in Eq. (10). The geometry for this problem is shown in FIG. 3.

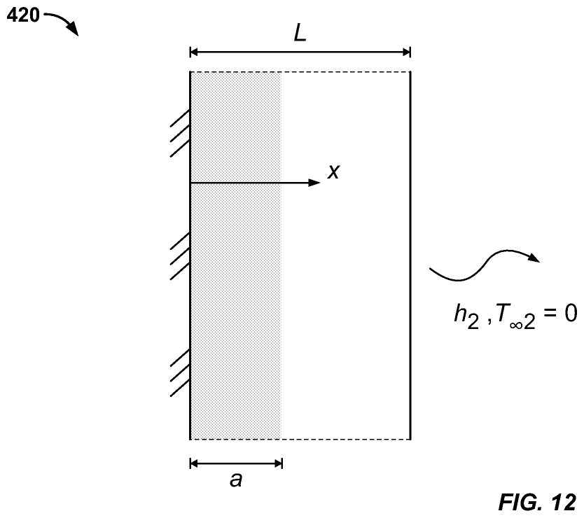

An exact analytic solution for this problem is given by:

$$\tilde{T} ( \tilde{x} , \tilde{t} ) = {\tilde{T}}_{ss} ( \tilde{x} ) + {\tilde{T}}_{ct} ( \tilde{x} , \tilde{t} ) \qquad ( 57 )$$

where \tilde{T}ₛₛ is the steady state portion of the solution and \tilde{T}_{ct} is the complementary transient portion of the solution. The steady-state solution is piecewise in space. FIG. 12 shows a schematic of Example 1, the slab with piecewise internal heating, one insulated boundary, and one convection boundary.
For x≤a:

$${\tilde{T}}_{ss} ( x ) = \frac{1}{{B}_{1} {B}_{2} + {B}_{1} + {B}_{2}} [ ( - \frac{{B}_{1} {B}_{2}}{2} - \frac{{B}_{1}}{2} - \frac{{B}_{2}}{2} ) {x}^{2} + ( - \frac{{B}_{1} {B}_{2}}{2} {\tilde{a}}^{2} + {B}_{1} {B}_{2} \tilde{a} ) \tilde{x} + ( - \frac{{B}_{2} {\tilde{a}}^{2}}{2} + {B}_{2} {\tilde{a}}^{2} + {\tilde{a}}^{2} ) ] \qquad ( 58 )$$

For x>a:

$${\tilde{T}}_{ss} ( \tilde{x} ) = \frac{1}{{B}_{1} {B}_{2} + {B}_{1} + {B}_{2}} [ ( - \frac{{B}_{1} {B}_{2} {\tilde{a}}^{2}}{2} - {B}_{2} {\tilde{a}}^{2} ) \tilde{x} + ( \frac{{B}_{1} {B}_{2}}{2} {\tilde{a}}^{2} + \frac{{B}_{1}}{2} {\tilde{a}}^{2} + {B}_{2} {\tilde{a}}^{2} + {B}_{1} {\tilde{a}}^{2} ) ] \qquad ( 59 )$$

The complementary transient portion is given by

$${\tilde{T}}_{ct} ( \tilde{x} , \tilde{t} ) = - {\sum }_{m = 1}^{∞} exp ( - {β}_{m}^{2} \tilde{t} ) [ {β}_{m} cos ( {β}_{m} \tilde{x} ) + {B}_{1} sin ( {β}_{m} \tilde{x} ) ] \qquad ( 60 )$$

$$x \frac{sin ( {β}_{m} a ) - \frac{{B}_{1}}{{β}_{m}} cos ( {β}_{m} a ) + \frac{{B}_{1}}{{β}_{m}}}{{β}_{m}^{2} {N}_{m}}$$

$$where {N}_{m} = \frac{1}{2} [ ( {β}_{m}^{2} + {β}_{1}^{2} ) ( 1 + \frac{{B}_{2}}{{β}_{m}^{2} + {β}_{2}^{2}} ) + {B}_{1} ] \qquad ( 61 )$$

$$where {β}_{m} satisfies tan {β}_{m} = \frac{{β}_{m} ( {B}_{1} + {B}_{2} )}{{β}_{m}^{2} - {B}_{1} {B}_{2}}$$

The above solution is actually for Example 1, but the insulated boundary at x=0 may be obtained from this solution, to high precision, by taking B₁ small, say 10⁻¹⁰.

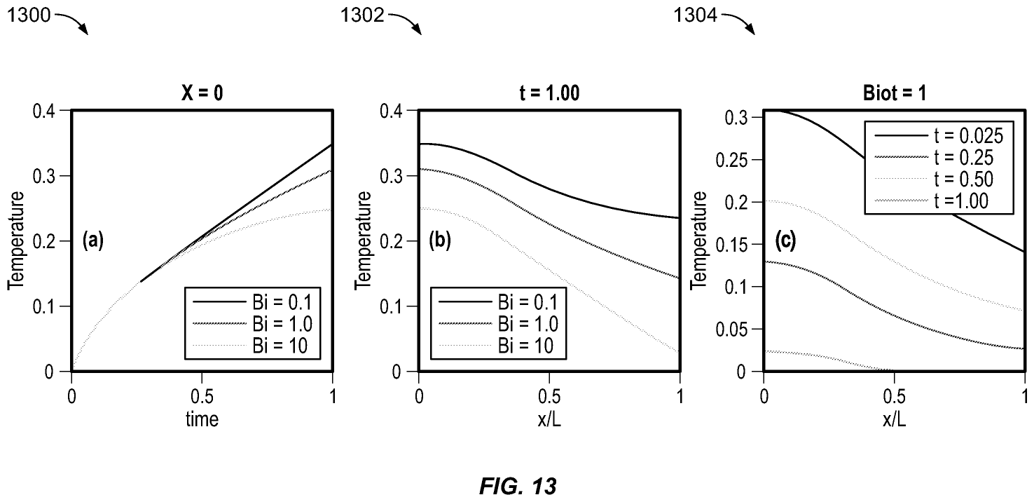

Some temperature values for Example 1 are shown in FIG. 13 which were computed from the exact solution, Eq. (57-61). FIG. 13 graph 1300 shows temperature versus time at the x=0 insulated boundary for three values of the Biot number at x=L. Note the temperature for different Biot numbers rise at the same initial rate, and then the effect of the boundary at x=L causes the values for different Biot to diverge for t>0.4. FIG. 13 graph 1302 shows the temperature versus position at t=1.0 for three values of the Biot number. FIG. 13 graph 1304 shows temperature versus position at four dimensionless times for Biot=1.0.

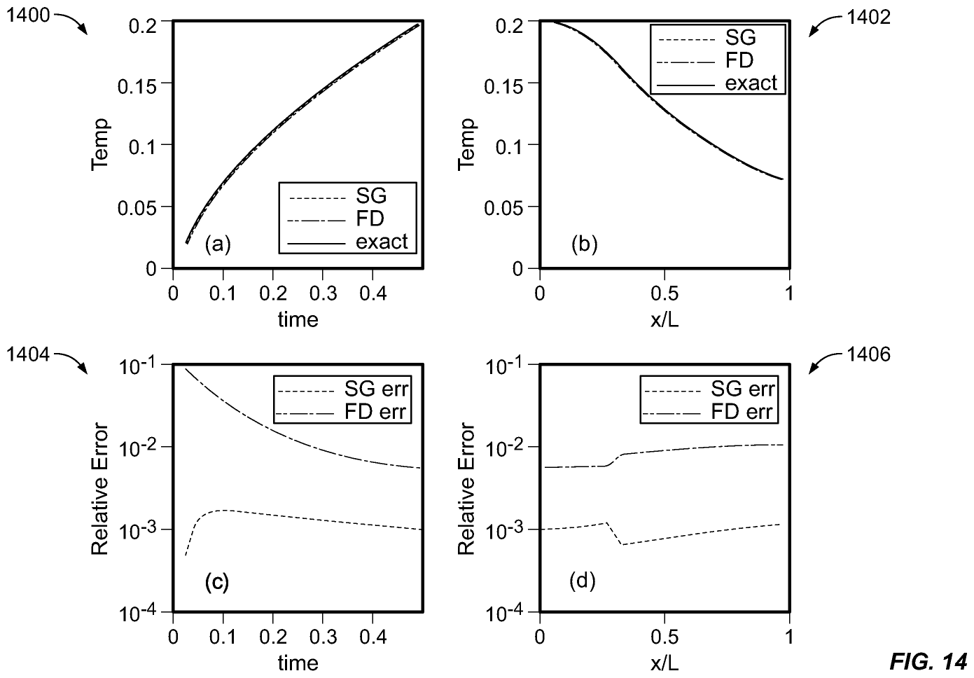

Next a comparison is made between temperature values computed from the exact solution, from the SG method, and from a fully implicit finite difference solution. Temperatures from the SG method for this problem were computed from Eq. (52) with Laplacian given in Eq. (43) and edge weights from Eq. (48). In FIG. 14 the comparison is made for the specific conditions B₂=1.0, nt=20, and nx=20. FIG. 14 graph 1400 and graph 1402 show the temperature, while graph 1404 and graph 1406 show the relative error |T−T_{exact}|/T_{exact}. The numerical results are close to the exact values, even though the grid is coarse and the timesteps are few. The errors for the SG method are smaller than those of FD method by about an order of magnitude even at large times after the FD errors have decreased over time. The errors for both methods are insensitive to position, except near the heated/unheated boundary at a/L=0.3.

The error was also computed from the temperature history at x=0 over the time range

(0<\tilde{t}<1), for several combinations of spatial nodes nx and the number of timesteps nt. For each temperature history the symmetric mean absolute percentage error was computed, defined by

$$S M A P E = \frac{1}{nt} {\sum }_{i = 1}^{nt} \frac{\vert {T}_{ex} ( {t}_{i} ) - T ( {t}_{i} ) \vert}{{T}_{ex} ( {t}_{i} + T ( {t}_{i} )} X 100 \% \qquad ( 62 )$$

where nt is the number of timesteps, Tₑₓ(tᵢ) is the exact temperature and T(tᵢ) is the numerically computed temperature. The SMAPE results for several temperature histories are listed in Table 2. The errors for the SG method are insensitive to the number of timesteps; recall that the SG method is analytic in time. At nt=20 and Biot=0.1 the SG method has much lower error than the FD method. As nt increases at Biot=0.1, the error for the FD method does not become comparable to the SG method until nt=500. The SG method is sensitive to the number of nodes, improving from about 0.4% error at nx=11 to 0.006% error at nx=101, for Biot=0.1, and with similar trends at Biot=10. In contrast the error for the FD method has no clear trend as nx increases. All of the errors in Table 2 are small, less than 0.5% for the SG method and less than 4% for the FD method.

TABLE 2
Symmetric mean absolute percentage error (SMAPE) in SG and
FD values for Example 1 versus number of spatial nodes nx
and time steps nt. The comparison is made at the node closest
to the x = 0 boundary over the time range (0 < \tilde{t} < 1.0).
The body has steady internal heating over (0 < \tilde{x} < 0.30).

| Biot | nx | nt | SG-SMAPE | FD-SMAPE |
|---|---|---|---|---|
| 0.1 | 10 | 20 | 0.520526 | 1.536196 |
| | 20 | 20 | 0.129386 | 1.848599 |
| | 100 | 20 | 0.005166 | 1.975145 |
| | 10 | 100 | 0.516129 | 0.458758 |
| | 20 | 100 | 0.128656 | 0.367412 |
| | 100 | 100 | 0.005142 | 0.455034 |
| | 10 | 500 | 0.514297 | 0.459832 |
| | 20 | 500 | 0.128223 | 0.109446 |
| | 100 | 500 | 0.005126 | 0.087602 |
| 10 | 10 | 20 | 0.514859 | 2.085543 |
| | 20 | 20 | 0.127901 | 2.479438 |
| | 100 | 20 | 0.005106 | 2.604435 |
| | 10 | 100 | 0.509852 | 0.333806 |
| | 20 | 100 | 0.127022 | 0.456041 |
| | 100 | 100 | 0.005076 | 0.575285 |
| | 10 | 500 | 0.507904 | 0.429614 |
| | 20 | 500 | 0.126560 | 0.084016 |
| | 100 | 500 | 0.005058 | 0.111476 |

### 3.2 Example 2, Slab Body Heated at the Boundary

Example 2 is the temperature in a slab body which is suddenly heated on one boundary and cooled by convection on the other boundary, as follows

$$\frac{\partial \tilde{T}}{\partial \tilde{t}} = \frac{{\partial }^{2} \tilde{T}}{\partial {x}^{2}} \qquad ( 63 )$$

$$at \tilde{x} = 0 , - k \frac{\partial \tilde{T}}{\partial \tilde{x}} + {B}_{1} \tilde{T} = {B}_{1} {\tilde{T}}_{∞ 1} + \tilde{q} 1$$

$$at \tilde{x} = 1 , k \frac{\partial \tilde{T}}{\partial \tilde{x}} + {B}_{2} \tilde{T} = 0$$

$$at \tilde{t} = 0 , \tilde{T} ( \tilde{x} , 0 ) = 0$$

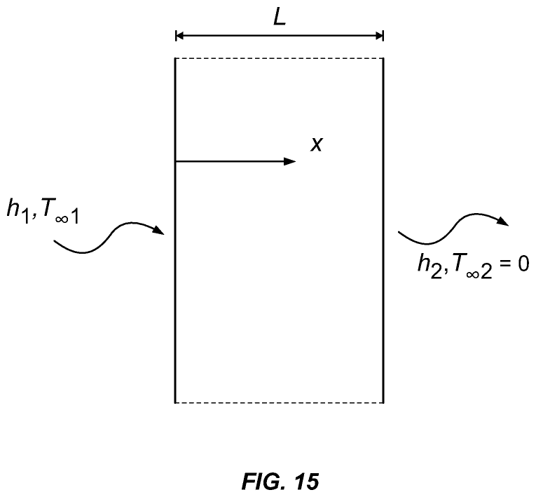

The geometry of Example 2 is shown in FIG. 15. The exact solution to this problem is given by:

$$\tilde{T} ( \tilde{x} , \tilde{t} ) = ( {B}_{1} {\tilde{T}}_{∞ 1} + \tilde{q} 1 ) [ \frac{1 + {B}_{2} ( 1 - \tilde{x} )}{{B}_{1} + {B}_{1} {B}_{2} + {B}_{2}} - {\sum }_{m = 1}^{∞} exp ( - {β}_{m}^{2} \tilde{t} ) \frac{{β}_{m} cos ( {β}_{m} \tilde{x} ) + {B}_{1} sin ( {β}_{m} \tilde{x} )}{{β}_{m} {N}_{m}} ] \qquad ( 64 )$$

and where Nₘ and βₘ are the same as for Example 1 in Eq. (60).

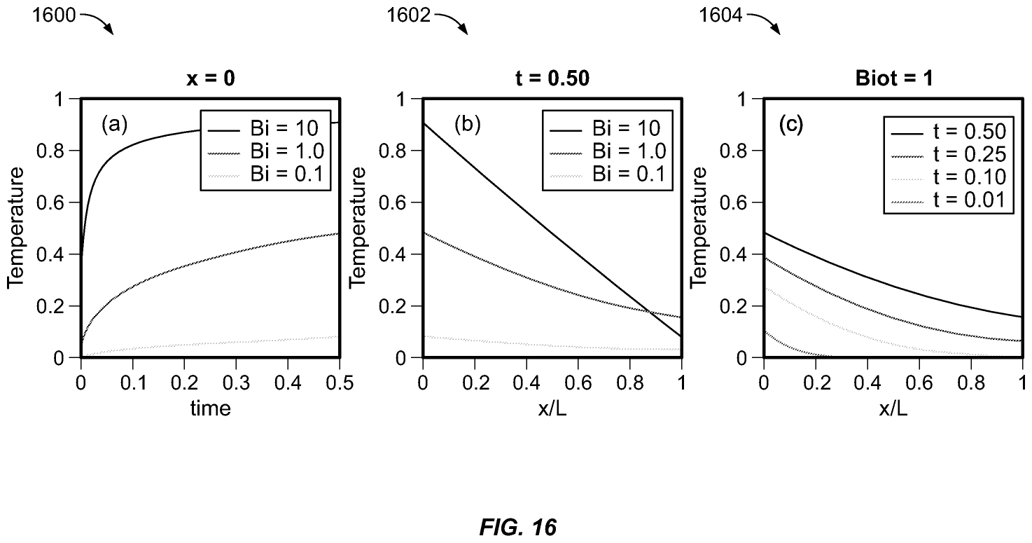

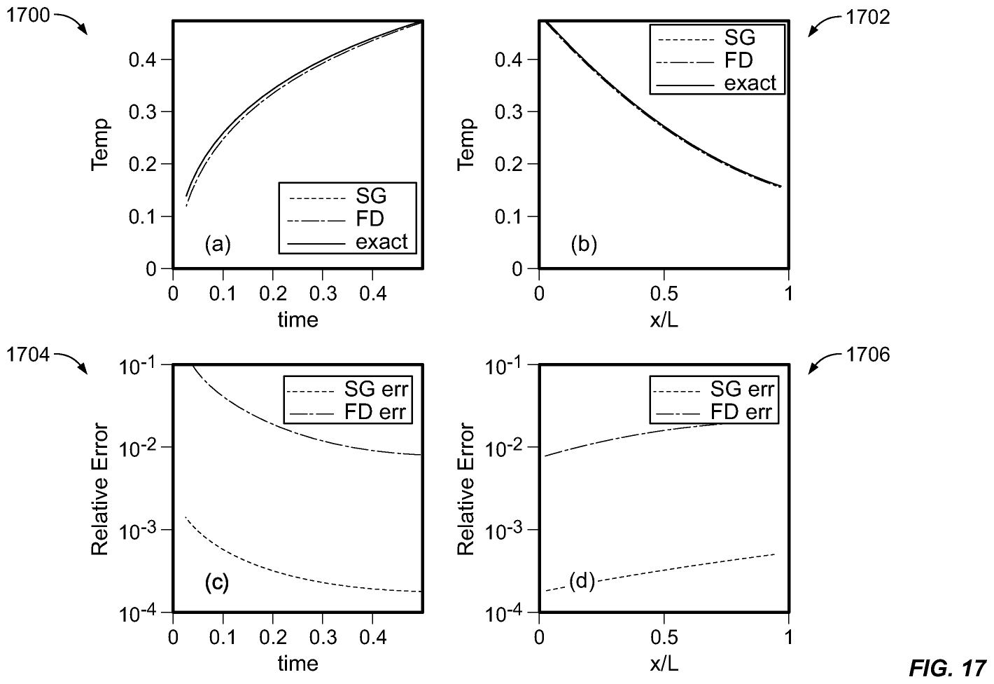

Some temperatures for Example 2 are shown in FIG. 16 which were computed from the exact solution, Eq. (58), for q1=0, \tilde{T}_{∞1}=1, and for B₁=B₂. In FIG. 16 graph 1600 shows the temperature history at the heated boundary for three values of the Biot number. At B₁=B₂=0.1 the temperature is small because heat enters the body slowly. As Biot number increases the rate of temperature rise at the heated boundary likewise increases. In FIG. 16 graph 1602 shows the temperature distribution at time t=0.5 for three values of the Biot number. In FIG. 16 graph 1604 shows the temperature distribution at Biot=1.0 for several values of the time.

Next a comparison is made between the exact solution, the SG method, and a fully implicit finite difference (FD) solution. Results for the SG method were computed using Eq. (32) applied to boundary heating at the first node, as follows:

$$\tilde{T} ( \tilde{x} , \tilde{t} ) = ∅ {Λ}^{- 1} {∅}^{′} \tilde{g} 1 - ∅ {Λ}^{- 1} {e}^{- Λ t} {∅}^{′} \tilde{g} 1 \qquad ( 65 )$$

$$where \tilde{g} 1 = \{ \begin{matrix}\frac{{A}_{1}}{{V}_{1}} {B}_{1} {T}_{∞ 1} ; & i = 1 \\ 0 ; & i = 2 , 3 , … n\end{matrix}$$

FIG. 8 shows the Example 2 results from all three methods for the specific case B₁=B₂=1.0, nt=20, and nx=20. FIGS. 8a and 8b show the temperature, and FIGS. 8c and 8d show the relative error |T−T_{exact}|/T_{exact}. The numerical results are very close to the exact values, even though the grid is coarse. The numerical methods have the highest error at early time and at the unheated boundary, and the SG method has smaller errors, by more than an order of magnitude, than the FD method under these conditions.

In a similar manner as before, the temperature error for Example 2 was studied at x=0 over the time range (0<\tilde{t}<0.5) for several combinations of spatial nodes nx and timesteps nt. Table 3 shows SMAPE values (see Eq. 62) from these time histories at two Biot values. The trends are similar to those for Example 1. All of the errors in Table 3 are small, everywhere less than 0.4% for the SG method and less than 3% for the FD method.

Table 3: Symmetric mean absolute percentage error (SMAPE) in SG and FD values, compared to the exact temperature, for Example 2. The comparison is made at the node closest to the x=0 boundary for (0<\tilde{t}<0.5), versus the number of spatial nodes nx and time steps nt. The body is heated at the x=0 boundary by suddenly-applied convection and cooled at x=L, with B₁=B₂.

| Biot | nx | nt | SG-SMAPE | FD-SMAPE |
|---|---|---|---|---|
| 0.1 | 10 | 20 | 0.016794 | 2.279459 |
| | 20 | 20 | 0.004972 | 2.185061 |
| | 100 | 20 | 0.000211 | 2.061667 |
| | 10 | 100 | 0.034616 | 0.654975 |
| | 20 | 100 | 0.005356 | 0.672146 |
| | 100 | 100 | 0.000236 | 0.624639 |
| | 10 | 500 | 0.135758 | 0.204108 |
| | 20 | 500 | 0.013928 | 0.166885 |
| | 100 | 500 | 0.000242 | 0.169607 |
| 10 | 10 | 20 | 0.194241 | 2.571212 |
| | 20 | 20 | 0.044629 | 1.990308 |
| | 100 | 20 | 0.001642 | 1.564184 |
| | 10 | 100 | 0.320654 | 1.100559 |
| | 20 | 100 | 0.076506 | 0.753417 |
| | 100 | 100 | 0.002751 | 0.537464 |
| | 10 | 500 | 0.357012 | 0.518863 |
| | 20 | 500 | 0.093795 | 0.282591 |
| | 100 | 500 | 0.003607 | 0.161027 |

### 3.3 Parallelepiped with Piecewise Initial Condition, Example 3

The method is applied to third simulation example of a parallelepiped with piecewise initial condition for which an exact analytical solution is available for verification. First the exact solution is given, and then the spectral graph method is applied to nodes distributed in a uniform grid and also with a block-random grid.

### 3.3.1 Exact Solution in the Parallelepiped

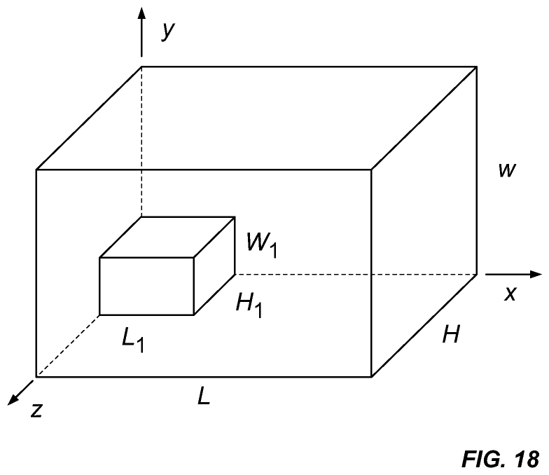

Consider heat conduction in a parallelepiped with a piecewise initial condition and with convection heat loss at the boundaries. The geometry is shown in FIG. 18. The temperature in the parallelepiped satisfies the following energy equation and boundary conditions:

$$\frac{{\partial }^{2} \tilde{T}}{\partial {\tilde{x}}^{2}} + \frac{1}{{\tilde{W}}_{2}} \frac{{\partial }^{2} \tilde{T}}{\partial {\tilde{y}}^{2}} + \frac{1}{{\tilde{H}}_{2}} \frac{{\partial }^{2} \tilde{T}}{\partial {\tilde{z}}^{2}} = \frac{\partial \tilde{T}}{\partial \tilde{t}} ; \{ \begin{matrix}0 < x < 1 \\ 0 < y < 1 \\ 0 < z < 1 \\ t > 0\end{matrix} \qquad ( 66 )$$

$$at \tilde{x} = 0 , - \frac{\partial \tilde{T}}{\partial \tilde{x}} + {B}_{x 1} \tilde{T} = 0$$

$$at \tilde{x} = 1 , - \frac{\partial \tilde{T}}{\partial \tilde{x}} - {B}_{x 2} \tilde{T} = 0$$

$$at \tilde{y} = 0 , - \frac{\partial \tilde{T}}{\partial \tilde{y}} + {B}_{y 1} \tilde{T} = 0$$

$$at \tilde{y} = 1 , - \frac{\partial \tilde{T}}{\partial \tilde{y}} - {B}_{y 2} \tilde{T} = 0$$

$$at \tilde{z} = 0 , - \frac{\partial \tilde{T}}{\partial \tilde{z}} + {B}_{z 1} \tilde{T} = 0$$

$$at \tilde{z} = 1 , - \frac{\partial \tilde{T}}{\partial \tilde{z}} - {B}_{z 2} \tilde{T} = 0 \qquad ( 67 )$$

$$\tilde{T} ( \tilde{x} , \tilde{y} , \tilde{z} , 0 ) = \{ \begin{matrix}1 ; & \tilde{x} < {\tilde{L}}_{1} ; \tilde{y} < {\tilde{W}}_{1} ; \tilde{z} < {\tilde{H}}_{1} \\ 0 ; & otherwise\end{matrix} \qquad ( 68 )$$

The above problem has been made dimensionless by the following parameters:

$$\tilde{x} = \frac{x}{L} ; \tilde{y} = \frac{y}{W} ; \tilde{z} = \frac{x}{H} ; \tilde{W} = \frac{W}{L} ; \tilde{H} = \frac{H}{L} \qquad ( 69 )$$

$${\tilde{L}}_{1} = \frac{{L}_{1}}{L} ; {\tilde{W}}_{1} = \frac{{W}_{1}}{W} ; {\tilde{H}}_{1} = \frac{{H}_{1}}{H} ; \tilde{t} = \frac{α t}{{L}^{2}} ; {\tilde{T}}_{1} = \frac{T}{{T}_{0}} ;$$

$${B}_{x 1} = \frac{{h}_{x 1} L}{k} ; {B}_{x 2} = \frac{{h}_{x 2} L}{k} ; {B}_{y 1} = \frac{{h}_{y 1 W}}{k} ; {B}_{y 2} = \frac{{h}_{y 2} W}{k}$$

$${B}_{z 1} = \frac{{h}_{z 1} H}{k} ; {B}_{z 2} = \frac{{h}_{z 2} H}{k} ;$$

The dimensionless temperature in the parallelepiped is given by:

$$\tilde{T} ( \tilde{x} , \tilde{y} , z , t ) = 8 [ {\sum }_{m = 1}^{∞} \frac{{X}_{m} ( \tilde{x} ) {IX}_{m}}{{N}_{x}} e - {β}_{m}^{2} \tilde{t} ] [ {\sum }_{n = 1}^{∞} \frac{{Y}_{m} ( \tilde{y} ) {IY}_{m}}{{N}_{y}} e - {y}_{n}^{2} \tilde{t} / {\tilde{W}}^{2} ] [ {\sum }_{p = 1}^{∞} \frac{{Z}_{p} ( \tilde{y} ) {IZ}_{m}}{{N}_{z}} e - {n}_{p}^{2} \tilde{t} / {H}^{2} ] \qquad ( 70 )$$

$$where$$

$${X}_{m} ( \tilde{x} ) = {β}_{m} cos ( {β}_{m} \tilde{x} ) + {B}_{x 1} sin ( {β}_{m} \tilde{x} )$$

$$1 {X}_{m} = \frac{1}{{β}_{m}} [ {B}_{x 1} + {β}_{m} sin ( {β}_{m} {\tilde{L}}_{1} ) - {B}_{x 1} cos ( {β}_{m} {\tilde{L}}_{1} ]$$

$${N}_{x} = ( {β}_{m}^{2} + {B}_{x 1}^{2} ) [ 1 + \frac{{B}_{x 2}}{{β}_{m}^{2} + {B}_{x 2}^{2}} ] + {B}_{x 1}$$

$${Y}_{n} ( \tilde{y} ) = {γ}_{n} cos ( {γ}_{n} \tilde{y} ) + {B}_{y 1} sin ( {γ}_{n} \tilde{y} )$$

$${IY}_{n} = \frac{1}{{γ}_{n}} [ {B}_{y 1} + {γ}_{n} sin ( {γ}_{n} {\tilde{W}}_{1} ) - {B}_{y 1} cos ( {γ}_{n} {\tilde{W}}_{1} ) ]$$

$${N}_{y} = ( {γ}_{n}^{2} + {B}_{y 1}^{2} ) [ 1 + \frac{{B}_{y 2}}{{γ}_{n}^{2} + {B}_{y 2}^{2}} ] + {B}_{y 1}$$

$${Z}_{p} ( \tilde{z} ) = {n}_{p} cos {n}_{p} \tilde{z} ) + {B}_{z 1} sin ( {n}_{p} \tilde{z} )$$

$$1 {Z}_{p} = \frac{1}{{n}_{p}} [ {B}_{z 1} + {n}_{p} sin ( {n}_{p} {\tilde{H}}_{1} ) - {B}_{z 1} cos ( {n}_{p} {\tilde{H}}_{1} ) ]$$

$${N}_{z} = ( {n}_{p}^{2} + {B}_{z 1}^{2} ) [ 1 + \frac{{B}_{z 2}}{{n}_{p}^{2} + {B}_{z 2}^{2}} ] + {B}_{z 1} \qquad ( 71 )$$

Eigenvalues βₘ, γₙ, and ηₚ are roots of the following relations

$$tan {β}_{m} = \frac{{β}_{m} ( {B}_{x 1} + {B}_{x 2} )}{cos θ} ; tan γ n = \frac{γ n ( {B}_{y 1} + {B}_{y 2} )}{{γ}_{n}^{2} - {B}_{y 1} {B}_{y 2}} ; tan {μ}_{p} \frac{- {μ}_{p} ( {B}_{z 1} + {B}_{z 2} )}{{μ}_{p}^{2} - {B}_{z 1} {B}_{z 2}} \qquad ( 72 )$$

The above series expression converges somewhat slowly when evaluated at small time, but even so ten-digit precision can be obtained for the time ranges needed here.

### 3.3.2 Numerical Results for Uniform Rectangular Grid

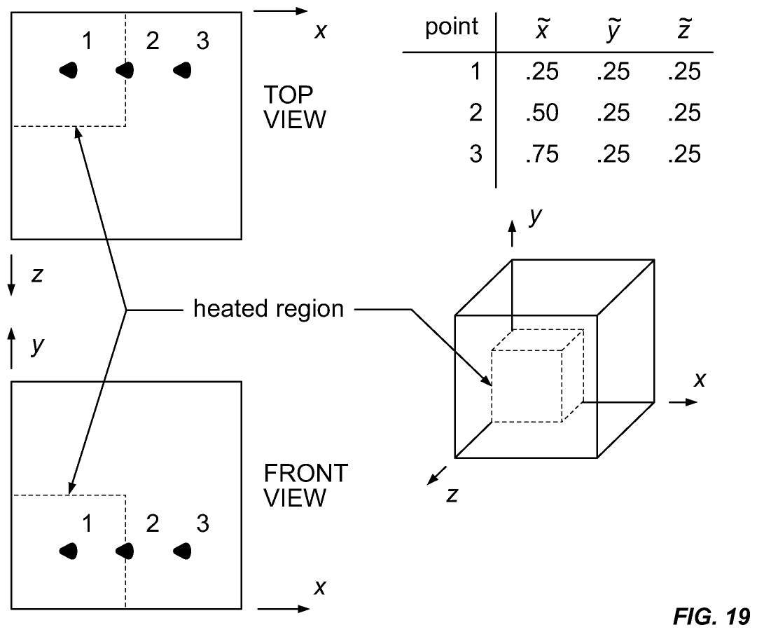

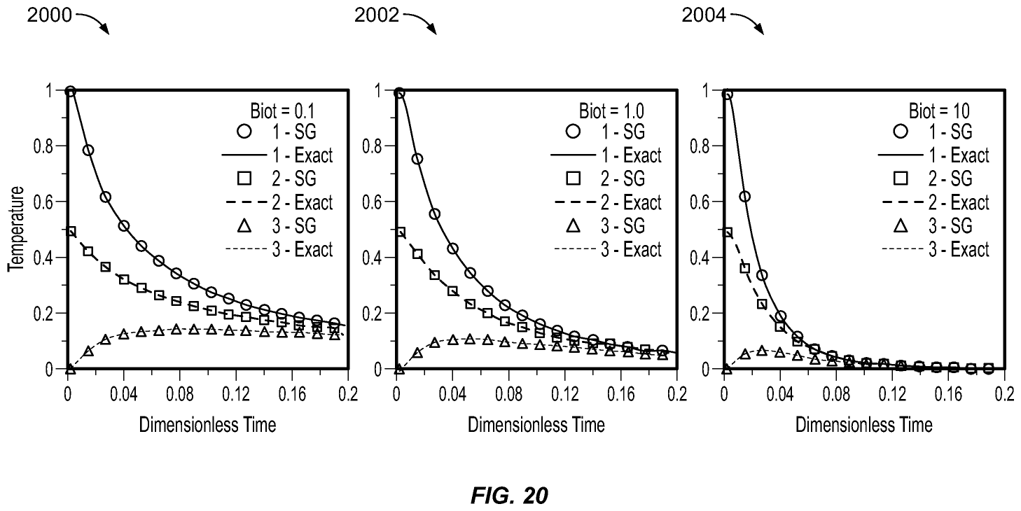

The spectral graph method was carried out for parallelepiped bodies which were initially hot over a small region (L₁=W₁=H₁=0.5). No calibration is needed for the uniform rectangular grid. The temperature was tracked at three points in each body, identified in FIG. 19 shows locations for observing temperature in the parallelepiped of the third Example simulation case. In FIG. 19, location (1) is at the center of the initially heated region, location (2) is at an interior face of the initially-heated region, and location (3) is outside the initially heated region. First an equal-sided body with L=W=H is studied. The temperature history at the three points is plotted versus time in FIG. 20 for spatially uniform heat transfer coefficient over all surfaces of the cube at levels Bi=0.1, 1.0, and 10, and for n/vol=1728 in a 12×12×12 grid. In FIG. 20, graph 2000 shows the temperate history of the three locations using Biot=0.1; graph 2002 shows the temperate history of the three locations using Biot=1.0; and graph 2004 shows the temperate history of the three locations using Biot=10. Parameters used for the SG solution were 1536 nodes per unit volume and 80 timesteps. In each graph 2000, 2002, and 2004, location (1) starts at \tilde{T}=1, location (2) starts at \tilde{T}=0.5, and location (3) starts at \tilde{T}=0. FIG. 11 shows that the SG solution agrees very closely with the exact solution. As the Biot number increases, the temperature at locations (1) and (2) fall more rapidly, and further towards zero. At location (3) the temperature first rises then falls, and for higher Biot number the peak temperature is lower. At large time (not shown) all the temperatures approach zero, and the time it takes to reach zero temperature decreases as the Biot number increases. That is, the cool down is faster at higher heat loss.

Two error measures are used to quantify the agreement between the SG method and the exact solution: the symmetric mean absolution percentage error (SMAPE) defined in

Eq. (62) and the root mean square error (RMSE) defined by

$$R M S E = \sqrt{\frac{1}{{n}_{t}} {\sum }_{k = 1}^{{n}_{t}} {( {T}_{SG}^{k} - {T}_{EX}^{k} )}^{2}} \qquad ( 73 )$$

Table 4 (below) shows the error measures for the SG solution at three locations, at three Biot numbers, over time range (0<\tilde{t}<0.2), for the equal-sided body L=W=H. Three different node densities are included at n/vol=512, 1728, and 4096. Table 4 shows that the SMAPE for n/vol=1728 (FIG. 11 data) is less than 0.5% and is less than 0.3% for the n/vol=4096 data. The error values increase slightly as Biot number increases.

TABLE 4
For the cube with L = W = H with uniform rectangular grid, error (SMAPE and
RMSE) for the SG method is compared to exact solution at locations shown in
FIG. 9 at three grid densities and three Biot numbers.

| | | | SMAPE | | | RMSE | | |
|---|---|---|---|---|---|---|---|---|
| H/L | loc | $\frac{nodes}{vol}$ | Bi = 0.1 | Bi = 1.0 | Bi = 10. | Bi = 0.1 | Bi = 1.0 | Bi = 10. |
| 1.0 | 1 | 512 | 0.318811 | 0.448006 | 0.870092 | 0.007398 | 0.010026 | 0.016782 |
| | | 1728 | 0.141872 | 0.198788 | 0.386930 | 0.003398 | 0.004616 | 0.008010 |
| | | 4096 | 0.079635 | 0.111562 | 0.217432 | 0.001920 | 0.002617 | 0.004614 |
| | 2 | 512 | 0.246750 | 0.449466 | 0.563780 | 0.002870 | 0.004095 | 0.006862 |
| | | 1728 | 0.109734 | 0.198981 | 0.248496 | 0.001309 | 0.001865 | 0.003206 |
| | | 4096 | 0.061604 | 0.111649 | 0.139236 | 0.000739 | 0.001054 | 0.001833 |
| | 3 | 512 | 0.670107 | 0.927687 | 0.978781 | 0.001884 | 0.001936 | 0.001538 |
| | | 1728 | 0.321845 | 0.435693 | 0.459108 | 0.000878 | 0.000903 | 0.000728 |
| | | 4096 | 0.184793 | 0.248705 | 0.261999 | 0.000497 | 0.000512 | 0.000414 |

The study depicted in FIG. 20 and Table 4 for the equal-sided body was repeated for three other parallelepipeds. Specifically, box-shaped bodies were studied with square cross section W/L=1 but with varying length along the z axis described by H/L=0.5, 0.75, and 1.5. The initial condition was identical (L₁=W₁=H₁=0.5) and the same temperature-observation locations were used (see FIG. 19). The temperature from the SG method for these bodies was compared to the exact solution as before. The temperature plots, omitted for brevity, show close agreement with the exact solution. Table 5 shows the SMAPE and RMSE error values for one body, the parallelepiped W/L=1 and H/L=1.5, for three values of the Biot number and for three node densities. Note that the error values are very close in size to those for the equal-sided body (H/L=1) shown in Table 4. Error values for two additional body shapes H/L=0.5 and H/L=0.75 (not shown in the interest of brevity) are also comparable to those in Tables 4 and 5. The point of the discussion is that the SG method can provide high precision temperature values for a variety of body shapes at various levels of surface heat loss, and the level of precision depends strongly on the node density and less strongly on the Biot number.

TABLE 5
For the parallelepiped with (L, W, H) = (1, 1, 1.5), error (SMAPE and RMSE)
for the SG method with uniform rectangular grid compared to exact solution at locations
shown in FIG. 9 at three grid densities and three Biot numbers.

| | | | SMAPE | | | RMSE | | |
|---|---|---|---|---|---|---|---|---|
| H/L | loc | $\frac{nodes}{vol}$ | Bi = 0.1 | Bi = 1.0 | Bi = 10. | Bi = 0.1 | Bi = 1.0 | Bi = 10. |
| 1.5 | 1 | 512 | 0.314239 | 0.456059 | 0.914614 | 0.007408 | 0.010030 | 0.016782 |
| | | 1728 | 0.139413 | 0.202147 | 0.407239 | 0.003403 | 0.004618 | 0.008010 |
| | | 4096 | 0.078168 | 0.113409 | 0.228961 | 0.001922 | 0.002618 | 0.004614 |
| | 2 | 512 | 0.253966 | 0.454544 | 0.585879 | 0.002884 | 0.004102 | 0.006862 |
| | | 1728 | 0.112648 | 0.201332 | 0.259505 | 0.001315 | 0.001868 | 0.003206 |
| | | 4096 | 0.063186 | 0.112990 | 0.145656 | 0.000742 | 0.001056 | 0.001833 |
| | 3 | 512 | 0.698852 | 0.929852 | 0.955982 | 0.001898 | 0.001940 | 0.001537 |
| | | 1728 | 0.334778 | 0.436741 | 0.448406 | 0.000884 | 0.000905 | 0.000728 |
| | | 4096 | 0.192099 | 0.249311 | 0.255869 | 0.000501 | 0.000513 | 0.000414 |

### 3.3.3 Numerical Results for Block-Random Grid

In this section temperature results are given for the improved spectral graph method carried out on block-random grids on the parallelepiped of the third Example. The body is divided into equal-sized blocks, and then a fixed number of nodes are placed in each block at random locations. This provides a large-scale uniform node distribution that is small-scale random. This method of node placement is appropriate for thermal simulation of an additive manufacturing process by the spectral graph method, in which the body shape changes as layers (or hatches) are added. The random placement of nodes in each added layer (or hatch) is straightforward and computationally efficient.

Several block-random grids were created for the cube-shaped part by specifying the same number of blocks along each coordinate direction, n_{b}, and the number of nodes within each block, n_{g}. Table 4 shows the total number of nodes in grids created from different combinations of n_{b} and n_{g}. For example, n_{b}=4 and n_{g}=3 give the total number of nodes as 4×4×4×3=192. To study the effect of random node locations within blocks, ten grids were created by different random embodiments of each block-grid combination studied, and the results are reported as the mean and variance over these ten grids. The randomly determined points within each block were sampled from a finely divided grid placed on each block, without replacement. In the present work each block was subdivided into 63=216 points.

TABLE 6
Number of nodes in a parallelepiped body created by np blocks along each axis
$and {n}_{g} nodes within each block . Total number of nodes = {n}_{b}^{3} {n}_{g} .$

| | ng | | | | | | | |
|---|---|---|---|---|---|---|---|---|
| nb | 1 | 2 | 3 | 4 | 5 | 6 | 7 | 8 |
| 4 | 64 | 128 | 192 | 256 | 320 | 384 | 448 | 512 |
| 6 | 216 | 432 | 648 | 864 | 1080 | 1296 | 1512 | 1728 |
| 8 | 512 | 1024 | 1536 | 2048 | 2560 | 3072 | 3584 | 4096 |

The calibration procedure for obtaining the gain factor involves a data-fitting procedure between the SG method and the exact solution (refer to Section 2.4.3). The benchmark data for the comparison is the time history of the temperature from the exact solution in the time range (0,0.2) at the center of the initially heated region for a cubic body. Twenty temperature values at uniformly-spaced time points were used. The data fitting procedure was the minimization of the sum-of-square error between the exact solution and the SG model carried out with a Gauss-Newton method. The method converged to four-digit precision in about six iterations and the resulting gain factor was not sensitive to the initial guess.

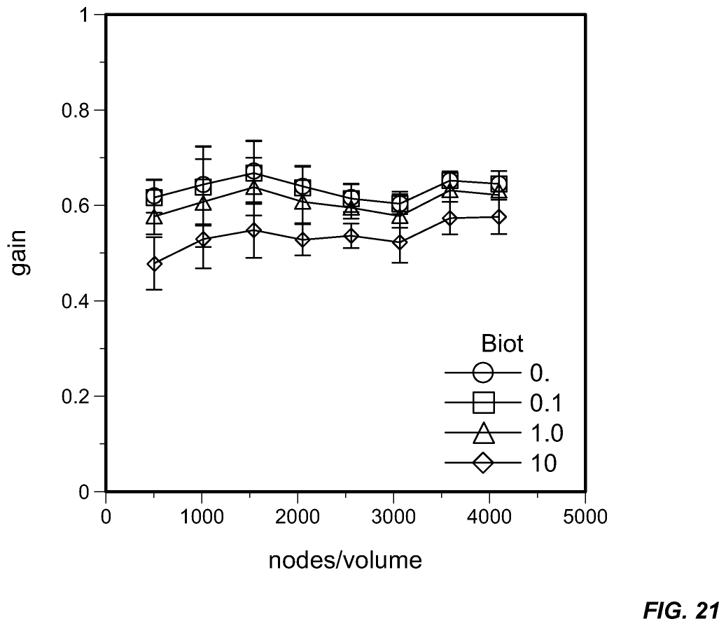

The calibration was carried out for several block-random grids at several Biot numbers. Ten block-random grids were studied for each node density so that averages and variance could be found. The resulting average gain factor is plotted in FIG. 21 versus node density (n/vol) and the variances are shown as error bars. FIG. 21 shows that the gain factor resides in a narrow band of values in the range (0.48-0.67), and has no clear trend as node density n/vol varies.

In examining these values it is important to consider the application to metal additive manufacturing. In cooling of metal the Biot number is usually small. For example, for a large stainless steel part (L=15 cm and k≈20 W/m/K) exposed to a large heat transfer coefficient (h=100 W/m²/K), the Biot number is Bi=100·0.15/20=0.75. Other metals with higher thermal conductivity give even lower values of the Biot number. This suggests that the gain values in FIG. 21 should be examined for Bi≤1.0 values. For these smaller Biot values, the gain values lie in the range (0.58-0.67), a range of 14%, and the variation is smaller as the node density increases. This suggests that the gain is independent of the Biot number, so that one calibration is sufficient to characterize the spectral graph method for the range of Biot numbers found in metal additive manufacturing.

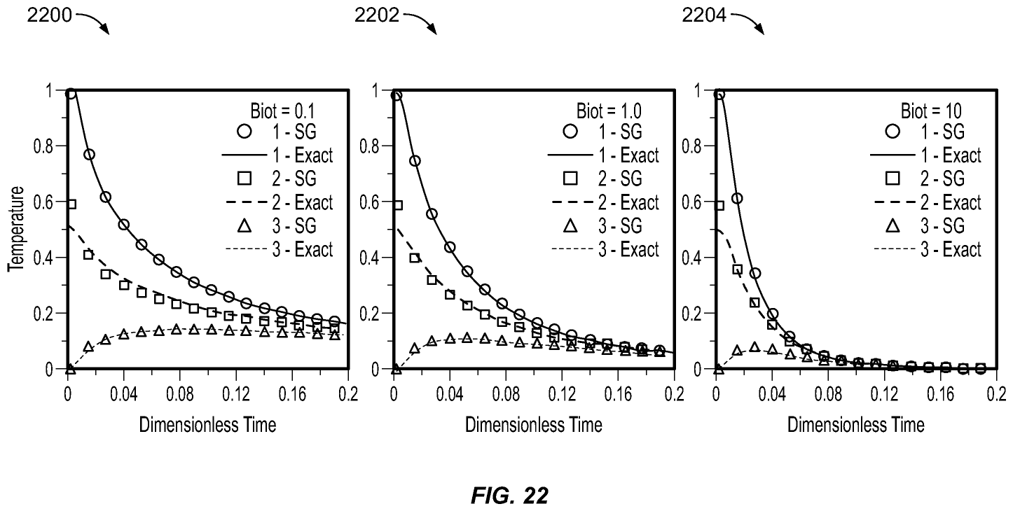

FIG. 22 shows temperature versus time for the SG method on a single block-random grid with node density 1536 (nodes per unit volume) compared to the exact solution at three locations shown in FIG. 19 and for three Biot numbers. In FIG. 22, graph 2200 shows the temperate history of the three locations using Biot=0.1; graph 2202 shows the temperate history of the three locations using Biot=1.0; and graph 2204 shows the temperate history of the three locations using Biot=10. Parameters used for the SG solution were 1536 nodes on a block-random grid and 80 timesteps. The results agree very closely at location (1), the center of the heated region, because this location was used to fit the gain factor f. The agreement is also good at location (3) (unheated region). At location (2) the SG method slightly overestimates the temperature at early time and slightly underestimates the temperature at middle time. The long time temperature trends are correct at all locations.

As before, a quantitative measure of the error in the SG method for the block-random grid is provided by SMAPE defined in Eq. (62) and RSME defined in Eq. (73) as shown in Table 7. Table 7 shows error values for the block-random grid at three locations, three Biot numbers, and three grid densities. To address the issue of randomness in assigning node locations, ten different block-random grids were created for each node density to obtain the averages and variances reported in Table 7.

Table 7 shows that the SMAPE error for n/vol=1536 is everywhere less than 10% and less than 6% for n/vol=4096, with the highest value for Biot=10 (high cooling rate). The RMSE errors are included because SMAPE errors skew large at large Biot number, because of division by very small temperature values at later times. The RMSE values for n/vol=1536 are everywhere less than 0.019 and less than 0.014 for n/vol=4096. No exploration of the number of time steps is included here; error in the spectral graph method varies little with the number of time steps, which was evident earlier in Table 3 for the one-dimensional example. Recall that the SG method is analytic in time, as discussed in Section 2.5.

Earlier the Biot number was identified to be in the range Bi≤1.0 for metal additive manufacturing. For this limited range of Biot values, the SMAPE errors in Table 7 for n/vol=1536 are everywhere less than 6% and are less than 3% for n/vol=4096.

TABLE 7
Error in temperature for the SG method on the block-random grid at three
locations defined in FIG. 10 and for three Biot numbers. For each grid density n/vol, ten
block-random grids were studied to obtain averages and variances over time range
(0 < t < 0.2).

| | | | SMAPE | | RMSE | |
|---|---|---|---|---|---|---|
| Location | Bi | n | average | variance | average | variance |
| 1 | 0.1 | 512 | 1.876834 | 0.331491 | 0.01719120 | 0.00001359 |
| | | 1536 | 0.940356 | 0.156959 | 0.00992803 | 0.00000993 |
| | | 4096 | 0.935124 | 0.234455 | 0.00887210 | 0.00001160 |
| | 1 | 512 | 2.753140 | 0.660255 | 0.01666274 | 0.00000743 |
| | | 1536 | 1.520414 | 0.395436 | 0.01001318 | 0.00000968 |
| | | 4096 | 1.090323 | 0.276723 | 0.00785373 | 0.00000529 |
| | 10 | 512 | 6.598844 | 7.072547 | 0.01498143 | 0.00000495 |
| | | 1536 | 5.905686 | 10.858103 | 0.01013748 | 0.00000395 |
| | | 4096 | 3.859102 | 3.502287 | 0.00782939 | 0.00000339 |
| 2 | 0.1 | 512 | 2.190329 | 1.210556 | 0.01494754 | 0.00006074 |
| | | 1536 | 2.393353 | 2.395105 | 0.01890678 | 0.00011668 |
| | | 4096 | 2.030881 | 1.911114 | 0.01358837 | 0.00007339 |
| | 1 | 512 | 1.866639 | 0.454295 | 0.01264575 | 0.00005338 |
| | | 1536 | 2.829961 | 2.987142 | 0.01816824 | 0.00012125 |
| | | 4096 | 1.944417 | 2.135573 | 0.01215211 | 0.00006857 |
| | 10 | 512 | 5.921486 | 12.519991 | 0.01069555 | 0.00005730 |
| | | 1536 | 8.302355 | 28.161460 | 0.01847190 | 0.00022798 |
| | | 4096 | 4.754935 | 9.625067 | 0.01063742 | 0.00003648 |
| 3 | 0.1 | 512 | 4.632983 | 4.616591 | 0.01179445 | 0.00002433 |
| | | 1536 | 4.022486 | 3.960269 | 0.01011096 | 0.00002245 |
| | | 4096 | 2.179375 | 1.051766 | 0.00550174 | 0.00000649 |
| | 1 | 512 | 5.234295 | 5.352751 | 0.01009804 | 0.00001224 |
| | | 1536 | 5.128025 | 6.565621 | 0.00960630 | 0.00002222 |
| | | 4096 | 2.755790 | 0.987612 | 0.00549648 | 0.00000388 |
| | 10 | 512 | 9.902535 | 33.144596 | 0.00645721 | 0.00000949 |
| | | 1536 | 9.050974 | 17.936956 | 0.00720693 | 0.00001416 |
| | | 4096 | 5.492360 | 3.038816 | 0.00443783 | 0.00000254 |

### 4 Validation with Experimental Data from Additive Manufacturing

Validation of the improved spectral graph method was carried out by comparison with experimental temperatures from infrared camera data obtained during a test build with the laser powder bed fusion (LPBF) process.

### 4.1 Experimental Setup

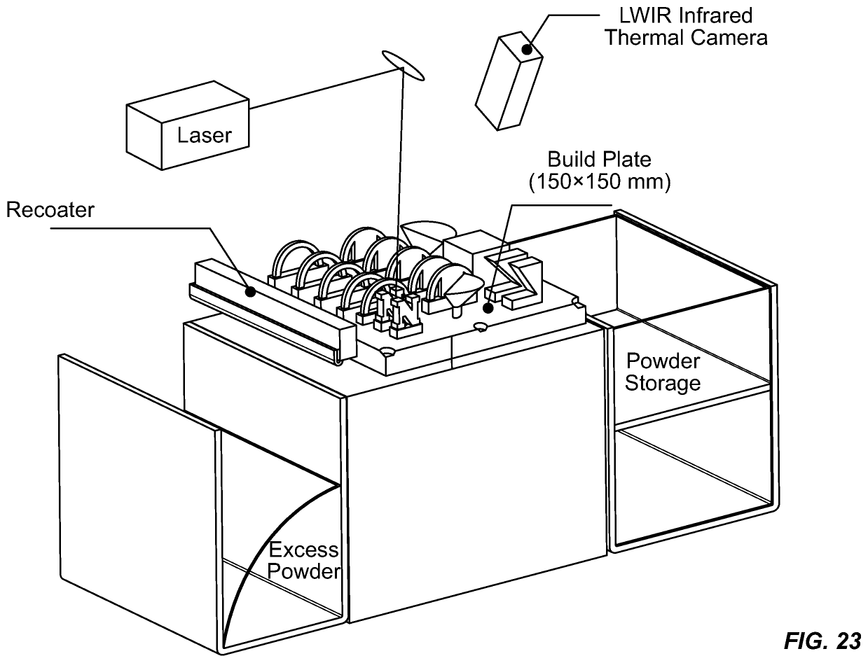

The additive manufacturing build was created on an open architecture LPBF system at Edison Welding Institute, Columbus, Ohio. A long wave infrared (LWIR) thermal camera was placed off-axis with an angle about 80° to the horizontal. A representative schematic along with an image of the experimental setup is in shown in FIG. 23. The Micro Epsilon model TIM-640 LWIR thermal camera used in the experiment has a resolution of 640 by 480 pixels. At the cameras height, the spatial resolution of the build plate was approximately 20 pixels per mm². The camera was calibrated according to a black-body technique. This calibration technique enabled the thermal camera to accurately measure top surface temperatures up to 550° C.

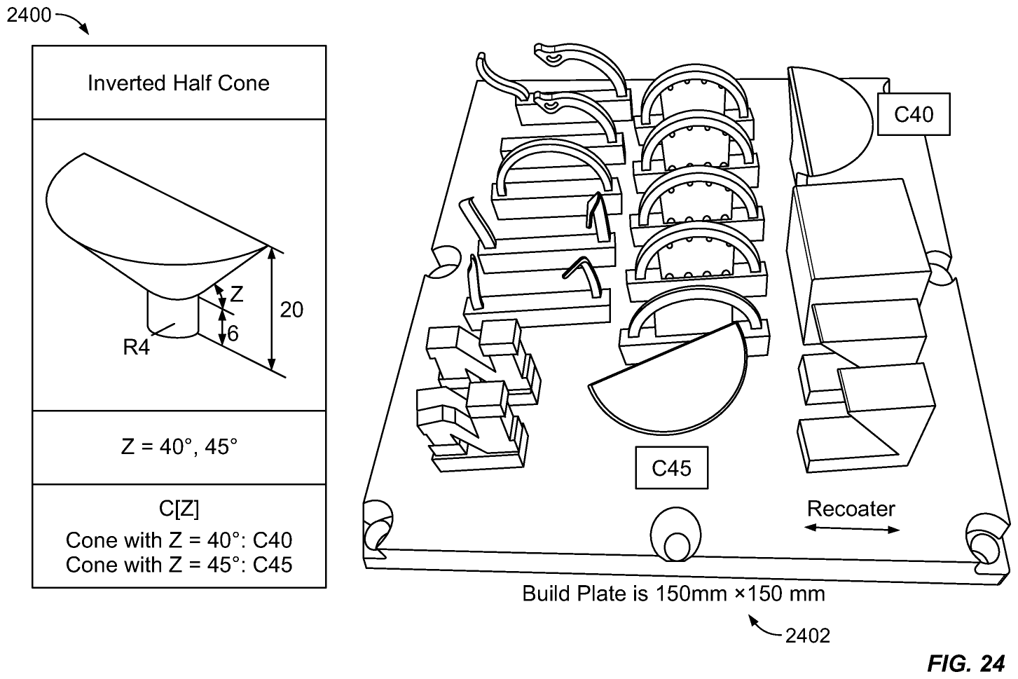

The parts in the experiment were made from the Inconel 718 powder. Seventeen parts were created from six different geometries, each with a different purpose. For the purposes of this work, data from two inverted half cones were studied with base height 6 mm, base radius 4 mm, and part height 20 mm. These two geometries as well as the completed build plate containing these parts are shown in FIG. 24. In FIG. 24, shows the inverted half cone geometry 2400 used to validate this work. In addition, two similar geometries were created, one with overhang angle 40 degrees C.40 and one with 45 degrees C.45. Completed build plate 2402 shows the two inverted half cones (C40, C45) used in this work. Other parts on this build plate were used for a different research topic. These two geometries with overhang were selected as they were expected to experience significant overheating, which can lead to superelevation and build failure in LPBF. For this reason, rapid prediction of the thermal history is of interest.

### 4.2 Experimental End-of-Cycle Temperature

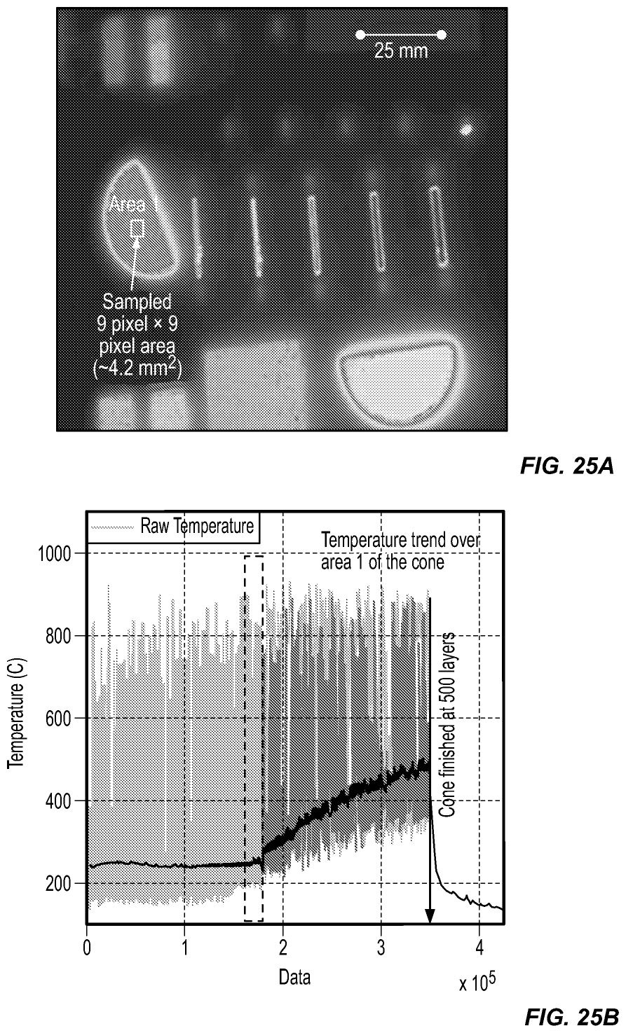

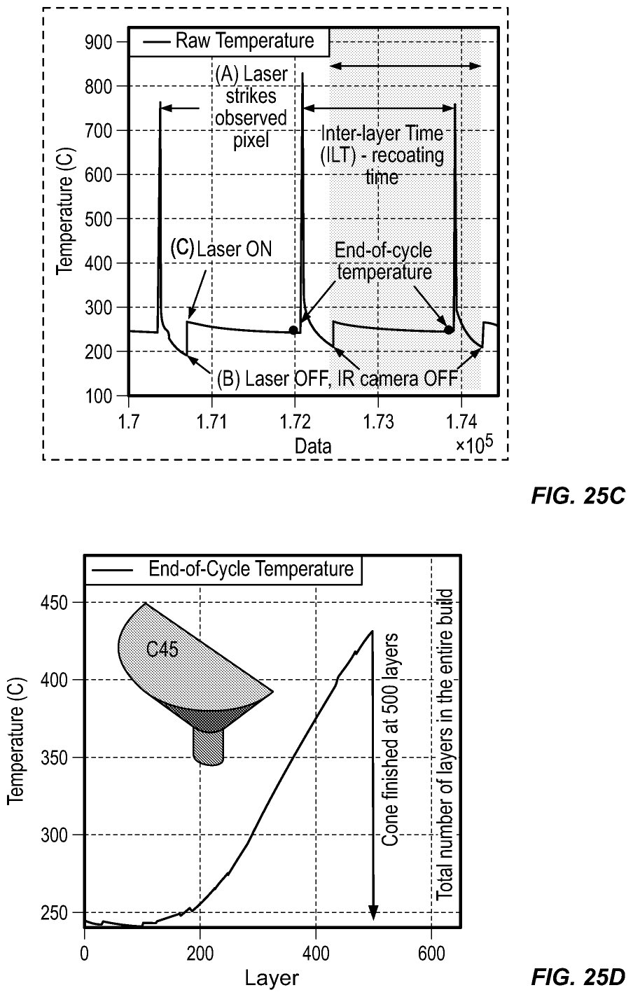

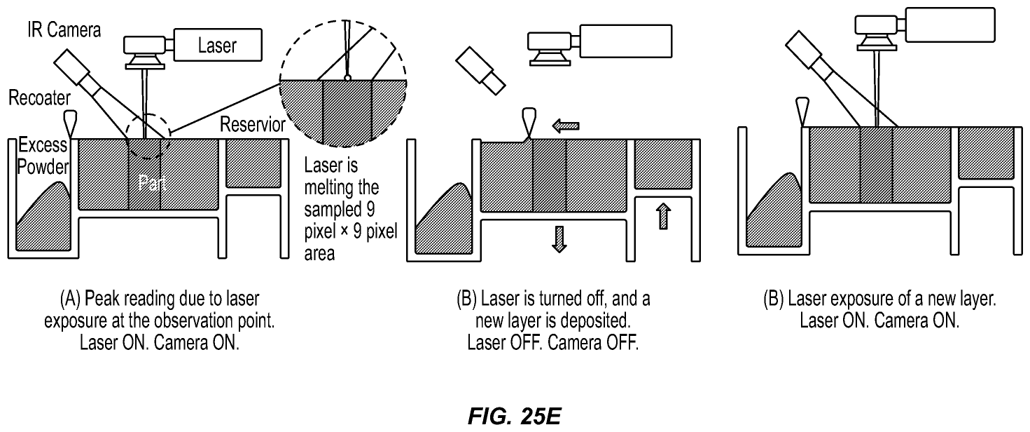

The procedure for obtaining the end-of-cycle surface temperature from the thermal images is described for the cone-shaped part with 45° inclination angle (C45). For C45, a 9 pixel by 9 pixel region from the IR camera data was selected. This sampled area is shown in FIG. 25A and equates to a 4 mm² area on the top surface of the part. Measurement near the edge of the part was avoided as the blur from the thermal image would lead to measurement error. Temperature readings from the infrared thermal camera image from this 4 mm2 area were averaged to obtain a top surface temperature. The temperature trend for this sampled region over the entire build duration of C45 is shown in FIG. 25B. The cone-shaped parts were completed at layer 500, the entire build completed at layer 650. A sample of the temperature trend over three layers is shown in FIG. 25C.

From the raw temperature data shown in FIG. 25B, the end-of-cycle surface temperature was extracted in the following manner. Referring to FIG. 25C, the raw temperature has three prominent features, demarcated (A), (B), and (C), which correspond to specific process events (illustrated in FIG. 25E). Note that the thermal camera acquires data only when the laser is active through a triggering mechanism. The first large spike marked (A) is when the laser is striking the sampled 4 mm² pixel region. The temperature recorded at (B) is momentarily interrupted at the time the laser and camera are both switched off. The epoch marked (C) and beyond is for the next layer processed by the laser. In the interim between (B) and (C) the recoater fetches powder, and a fresh powder layer is deposited.

The time for recoating is measured to be 11 seconds, and remains fixed irrespective of the process conditions or number of parts on the build plate. The temperature in the instant just before the laser strikes the sampled area again, before the melting of a new layer, is termed as the end-of-cycle surface temperature. Plotted in FIG. 25D is the end-of-cycle surface temperature for the 9 pixel by 9 pixel area (4 mm²) of the cone-shaped part C45 sampled in FIG. 25A.

### 4.3 Assumptions in the Thermal Model

There are several simplifying assumptions applied to both SG and FE methods for thermal modeling of the LPBF process. Because the duration of laser scan on one part (less than 0.5 s) is much shorter than interlayer time (>30 s), the laser scan is modeled as the instantaneous appearance of a newly fused layer. Latent heat effects of melting and fusing are neglected. The thermal model is carried out on a succession of heating cycles, with each cycle starting with the addition of the newly-fused layer and continuing to the end-of-cycle condition before the next laser scan. The interlayer time, which can vary throughout the build depending on the area to be fused at each layer, was obtained directly from the G-code, the machine language which encodes the processing parameters to carry out the actual build. The end-of-cycle temperature from one cycle is the initial condition for the body in the subsequent heating cycle, except for the newly-fused surface layer which increases the size of the computational domain.

There are some limitations specific to the SG method. The temperature problem must be linear, so that the material properties must not be functions of the temperature. In practice this means that the properties are evaluated at an appropriate average value during each heating cycle. To maintain symmetry of the Laplacian matrix the edge weights must be symmetric wᵢⱼ=wⱼᵢ, consequently spatial variation in the material properties are ruled out. Further, spatial variation in the node density is ruled out because each node must, on average, represent the same volume subset Vᵢ. In the present embodiment of the SG method, the newly-fused layer is added at the metal fusion temperature; this temperature and the size of the new layer determines the amount of thermal energy added in each heating cycle.

### 4.4 Calibration

Every numerical method contains parameters that must be chosen so that the results are physically meaningful. For the SG method, calibration is needed to find the gain factor using the method described in Section 2.4.3. The analytical solution described in Section 3.3 was used to compute a single heating/cooling cycle in an Inconel 718 parallelepiped depicted in FIG. 9 with each side of length 25 mm. The spectral graph method was applied to this geometry. and the gain factor was chosen to provide the best fit between the analytical solution and the spectral graph model. The comparison was carried out at the center of the initially-heated region. In this way the gain factor of f=0.555 was chosen at which the SMAPE was 0.4%. This gain factor was used for all subsequent model calculations. Other parameters used in the calibration are given in Table 8.

TABLE 8
Summary of simulation of parameters used for the gain
factor calibration and inverted half cone simulations.

| | Values |
|---|---|
| Parameters, calibration on parallelepiped | |
| Parallelepiped side length [mm] | 25 |
| Specific Heat [J kg⁻¹K⁻¹] | 435 |
| Conductivity [Wm⁻¹K⁻¹] | 19.47 |
| Density, [kg m⁻³] | 8,193 |
| Melting Point [C.] | 1,600 |
| Ambient chamber temperature, [C.] | 250 |
| Gain Factor | 0.555 |
| Parameters, simulation of inverted half cones | |
| Radius Factor (ϵ) | \sqrt{2.0} |
| Convection coeff. for build for | 0.1 |
| powder, h_{w} [Wm⁻²K⁻¹] | |
| Convection coeff. for build plate, | 300 |
| h_{b} [Wm⁻²K⁻¹] | |
| Superlayer thickness [mm] | 0.4 (10 actual layers) |
| Node density [nodes mm⁻³] | 1.0 |
| Computer hardware | Ryzen 3970X CPU |
| | 3.70 GHz, 128 GB RAM. |

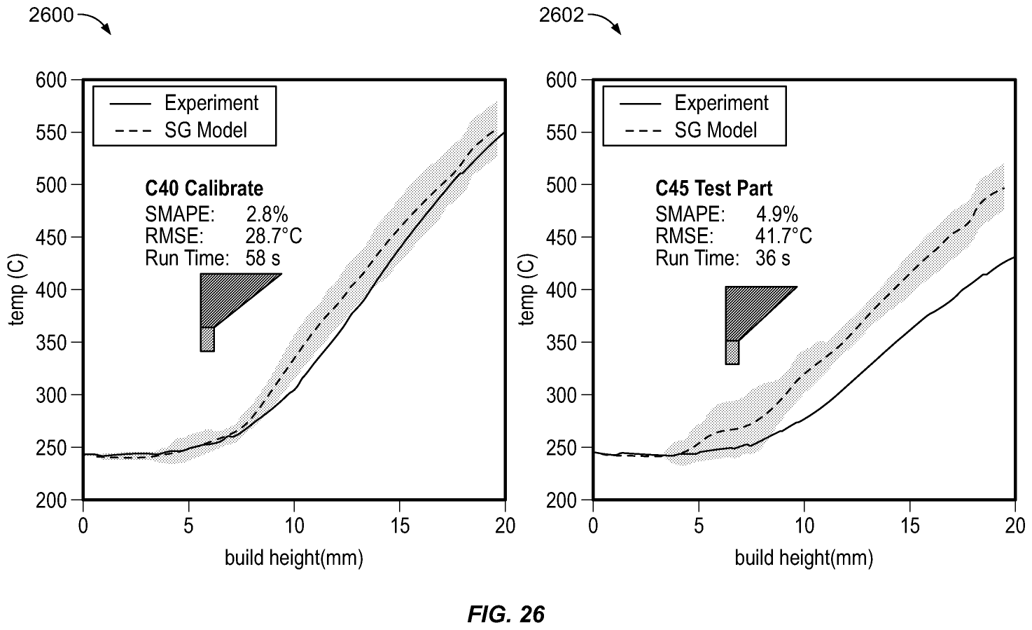

Another calibration step is to determine the correct level of heat loss for the simulation. To do this, the SG model was applied to inverted-cone geometry C40, with the larger overhang, and end-of-cycle temperatures were compared to data from the experimental build. The model was run with 50 superlayers, that is, 50 heating cycles in succession to represent the actual 500 layers in the build. The build plate on which the part is built, the primary heat sink in the problem, was modeled as a large convection coefficient (also called a contact conductance). The value of h_{b}=300 W/(m²K) was chosen for the build plate; this value is sufficiently large to represent a fixed-temperature boundary condition, because larger hb values give the same result. The effect of heat loss to the surrounding powder was modeled as another convection coefficient, to describe the heat loss to the low-conductivity metal powder on the sides of the fused part, and heat loss to the gas at the exposed upper surface of the fused part. To choose the heat-loss coefficient, the error (SMAPE) between the SG model for the C40 part and the end-of-cycle temperature obtained from the LWIR thermal camera was minimized. In this way the value of h_{w}=0.1 [W/m⁻² K⁻¹] was chosen; other parameters for the 50-layer simulation are provided in Table 8. The SG model for the calibration case is shown in FIG. 26 graph 2600. In both graphs 2600 and 2602, the dashed red lines are the ensemble average SG model values and the shaded region show the variance from ten block-random grids. The solid black lines are the experimentally measured values for each geometry. The dashed line shows the ensemble average of 10 computer runs using 10 different block-random grids and the shaded region shows the variance of the 10 different grids. The average error is less than 3% SMAPE and 29 degrees C. RMSE.

TABLE 9
Results of convergence study on node density applied to inverted
half cone C40. Density 1.0 node/mm³ was selected to balance decreases
in model error against increases in computation time.

| Node Density | Number | Time | SMAPE | RMSE |
|---|---|---|---|---|
| (node/mm³) | of nodes | (sec) | (%) | (° C.) |
| 0.3 | 1678 | 5.8 | 4.33 | 51.6 |
| 0.5 | 2804 | 16.1 | 4.36 | 47.9 |
| 0.8 | 4478 | 40.2 | 2.77 | 28.7 |
| 1 | 5565 | 58.2 | 2.72 | 28.3 |
| 1.5 | 8256 | 157.5 | 2.26 | 21.9 |
| 2 | 11094 | 171.0 | 1.83 | 17.1 |

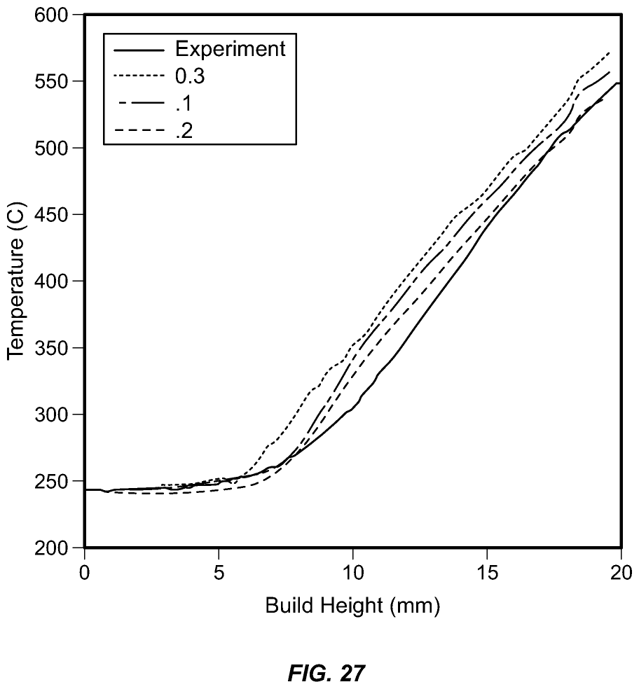

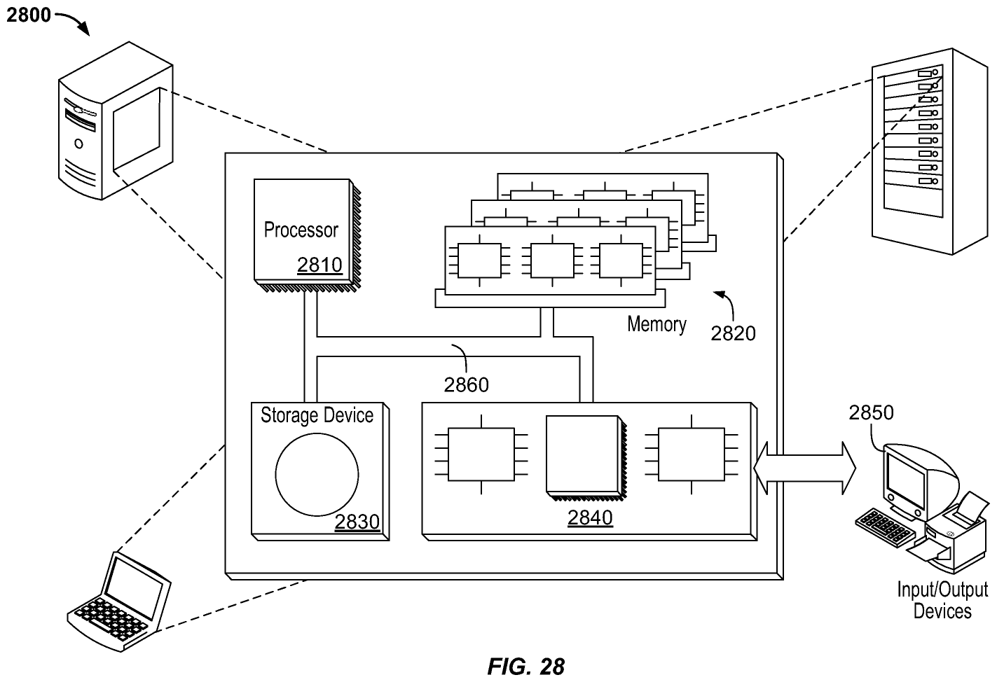

A convergence study was also carried out on the node density for the 50-layer simulation of the C40 part. FIG. 27 shows some of the results from this study compared to experimental data for the end-of-cycle temperature. Model results are shown for node density of 0.3, 1.0, and 2.0 nodes/mm³ and fixed gain factor f=0.555. A list of SMAPE error values from the temperature histories in the convergence study, along with computation time for each simulation, is given in Table 9. Table 9 shows that the chosen node density of 1.0 node/mm³ provides a good balance between rapid computation and acceptable precision.

### 4.5 Results for Test Case

Using the simulation parameters from calibration procedure, the simulation was carried out for the C45 geometry, with the smaller overhang. The results of the comparison between the SG model and the experimental data is presented in FIG. 26 graph 2602. The trends are correct and the general shape of the temperature is correct, with the error in the SG model prediction for the C45 part (test case) less than 5% SMAPE and 42 degree c. RMSE. The run time for the C45 test part is smaller than for the C40 calibration part because the smaller part volume contains fewer nodes at fixed node density.

The simulation for the C45 test case somewhat overestimates the end-of-cycle temperature in the overhang region of the part. This mismatch is primarily a function of the overall energy budget in each heating cycle, that is, heat in minus heat out. Evidence for this is the large Fourier number associated with one heating cycle, specifically, Fₒ=αt/L²=0.55 for α=5.46(10)⁻⁶ m²/s (Inconel), t=40 s (interlayer time at end of build) and L=20 mm (height at end of build). At this Fourier number the spatial details of the initial temperature are long forgotten and the temperature distribution is quasi-steady in space and decaying in time. To address the energy budget, areas for future work include improving heat addition in the simulation to more closely agree with the physics of laser absorption, and, improving heat loss to the surroundings, for example by including radiation heat loss.

### 5 Summary and Discussion

The SG method has been extended to directly incorporate heat loss with a generalized boundary condition, which is a distinct improvement over the ad hoc heat loss method used previously. Improved edge weights in the Laplacian matrix are now based on the physics of the problem, which reduces the number of calibration parameters and consequently simplifies the calibration process. The improved SG method has been used to develop a discrete Green's function for comprehensive treatment of several heating effects: space-varying initial conditions; time-and-space varying boundary heating; and, time-and-space varying internal heating. The precision of the method was determined from one-dimensional and three dimensional benchmark examples for which exact solutions were available. The one-dimensional examples were also compared with finite difference solutions. The method was also applied to a 50-layer simulation of an additive manufacturing process for two bodies with severe overhang, and the simulation results were validated by comparison with experimental temperature measurements. The model agrees with the experiments within 5% SMAPE with model computation time of less than one minute on a desktop computer. The rapid computation time of this improved thermal model provides an opportunity for application to flaw detection using real-time thermal sensor data; this is an area of ongoing research.

The computational advantage of the SG method applied to additive manufacturing comes from a combination of low-cost grid generation, only one eigenvalue solution to find the GF, and semi-analytic behavior on time which allows for time steps of any size. In contrast the finite element (FE) method has high-cost mesh generation and numerical time-integration with many small time steps required to control precision. The computational advantage of the SG method is strong for the rough and rapid thermal simulations that are presently sufficient to advance the field of thermal modeling of 3D printing. However, the computational cost of the eigenvalue problem in the SG method scales as O(n³), compared to the computational cost of the FE method which scales as O(m n²) where n is the number of nodes and m is the number of timesteps. This suggests that the computational advantage of the SG method may wane when n is large, for example, in simulation of large bodies. To address this concern, work is in progress to develop techniques for SG simulation of large bodies, to limit the number of nodes while maintaining acceptable precision.

FIG. 28 depicts an example computing system, according to implementations of the present disclosure. The system 2800 may be used for any of the operations described with respect to the various implementations discussed herein. The system 2800 may include one or more processors 2810, a memory 2820, one or more storage devices 2830, and one or more input/output (I/O) devices 2850 controllable via one or more I/O interfaces 2840. The various components 2810, 2820, 2830, 2840, or 2850 may be interconnected via at least one system bus 2860, which may enable the transfer of data between the various modules and components of the system 2800.

The processor(s) 2810 may be configured to process instructions for execution within the system 2800. The processor(s) 2810 may include single-threaded processor(s), multi-threaded processor(s), or both. The processor(s) 2810 may be configured to process instructions stored in the memory 2820 or on the storage device(s) 2830. For example, the processor(s) 2810 may execute instructions for the various software module(s) described herein. The processor(s) 2810 may include hardware-based processor(s) each including one or more cores. The processor(s) 2810 may include general purpose processor(s), special purpose processor(s), or both.

The memory 2820 may store information within the system 2800. In some implementations, the memory 2820 includes one or more computer-readable media. The memory 2820 may include any number of volatile memory units, any number of non-volatile memory units, or both volatile and non-volatile memory units. The memory 2820 may include read-only memory, random access memory, or both. In some examples, the memory 2820 may be employed as active or physical memory by one or more executing software modules.

The storage device(s) 2830 may be configured to provide (e.g., persistent) mass storage for the system 2800. In some implementations, the storage device(s) 2830 may include one or more computer-readable media. For example, the storage device(s) 2830 may include a floppy disk device, a hard disk device, an optical disk device, or a tape device. The storage device(s) 2830 may include read-only memory, random access memory, or both. The storage device(s) 2830 may include one or more of an internal hard drive, an external hard drive, or a removable drive.

One or both of the memory 2820 or the storage device(s) 2830 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 2800. In some implementations, the CRSM may include a data store that provides storage of computer-readable instructions or other information in a non-transitory format. The CRSM may be incorporated into the system 2800 or may be external with respect to the system 2800. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 2810 and the memory 2820 may be supplemented by, or incorporated into, one or more application-specific integrated circuits (ASICs).

The system 2800 may include one or more I/O devices 2850. The I/O device(s) 2850 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 2850 may also include one or more output devices such as a display, LED(s), an audio output device (e.g., a speaker), a printer, a haptic output device, and so forth. The I/O device(s) 2850 may be physically incorporated in one or more computing devices of the system 2800, or may be external with respect to one or more computing devices of the system 2800.

The system 2800 may include one or more I/O interfaces 2840 to enable components or modules of the system 2800 to control, interface with, or otherwise communicate with the I/O device(s) 2850. The I/O interface(s) 2840 may enable information to be transferred in or out of the system 2800, or between components of the system 2800, through serial communication, parallel communication, or other types of communication. For example, the I/O interface(s) 2840 may comply with a version of the RS-232 standard for serial ports, or with a version of the IEEE 1284 standard for parallel ports. As another example, the I/O interface(s) 2840 may be configured to provide a connection over Universal Serial Bus (USB) or Ethernet. In some examples, the I/O interface(s) 2840 may be configured to provide a serial connection that is compliant with a version of the IEEE 1394 standard.

The I/O interface(s) 2840 may also include one or more network interfaces that enable communications between computing devices in the system 2800, or between the system 2800 and other network-connected computing systems. The network interface(s) may include one or more network interface controllers (NICs) or other types of transceiver devices configured to send and receive communications over one or more communication networks using any network protocol.

Computing devices of the system 2800 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 2800 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to a suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. An additive manufacturing heat transfer simulation method executed by at least one processor, the method comprising:
converting a model of an object into a node representation of the object;
generating a network graph of the object based on the node representation;
for each block of nodes in the node representation:
applying a simulated heat to the block of nodes by multiple causation functions,
performing an energy balance of heat flow into and out of the node to determine the energy stored in the node, and
estimating a diffusion of heat to other nodes using physics based edge weights between nodes in the network graph; and
generating a representation of an estimated heat distribution within the object.

2. The method of claim 1, further comprising assembling node equations from energy balance relations at each node into a Laplacian matrix.

3. The method of claim 1, wherein the edge weights take a form of:
$${\tilde{w}}_{ij} = \{ \begin{matrix}\frac{1}{{ℓ}^{2}} exp ( \frac{{ℓ}^{2} - {\tilde{d}}_{ij}^{2}}{{σ}^{2}} ) ; & {\tilde{d}}_{ij} < \sqrt{2 ℓ} \\ 0 ; & {\tilde{d}}_{ij} \geq \sqrt{2 ℓ} , and i = j\end{matrix} , or$$
$${\tilde{w}}_{ij} = \{ \begin{matrix}\frac{f}{ℓ {d}_{ij}} ; & {\tilde{d}}_{ij} < \sqrt{2 ℓ} \\ 0 ; & {\tilde{d}}_{ij} \geq \sqrt{2 ℓ} , and i = j\end{matrix} .$$

4. The method of claim 1, wherein the causation functions comprise one or more of an internal heating function, an initial condition, and a boundary heating function.

5. The method of claim 1, wherein the causation functions comprise an internal heating function, an initial condition, and a boundary heating function.

6. The method of claim 1, wherein generating an network graph of the object based on the node representation comprises:
defining layers of nodes by sorting nodes of the node representation based on respective z-coordinates of the nodes;
defining hatches of nodes by sorting the nodes of the node representation based on respective y-coordinates of the nodes;
defining blocks of nodes by sorting the nodes in each hatch and layer into discrete blocks; and
building the network graph based on relationships between the nodes.

7. The method of claim 1, wherein the representation of the estimated heat distribution within the object comprises a representation of heat flux within the object.

8. The method of claim 1, wherein the representation of the estimated heat distribution within the object comprises a representation of temperature distribution within the object.

9. A system comprising:
at least one processor; and a data store coupled to the at least one processor having instructions stored thereon which, when executed by the at least one processor, causes the at least one processor to perform operations comprising:
converting a model of an object into a node representation of the object;
generating a network graph of the object based on the node representation;
for each block of nodes in the node representation:
applying a simulated heat to the block of nodes by multiple causation functions,
performing an energy balance of heat flow into and out of the node to determine the energy stored in the node, and
estimating a diffusion of heat to other nodes using physics based edge weights between nodes in the network graph; and
generating a representation of an estimated heat distribution within the object.

10. The system of claim 9, the operations further comprising assembling node equations from energy balance relations at each node into a Laplacian matrix.

11. The system of claim 9, wherein the edge weights take a form of
$${\tilde{w}}_{ij} = \{ \begin{matrix}\frac{1}{{ℓ}^{2}} exp ( \frac{{ℓ}^{2} - {\tilde{d}}_{ij}^{2}}{{σ}^{2}} ) ; & {\tilde{d}}_{ij} < \sqrt{2 ℓ} \\ 0 ; & {\tilde{d}}_{ij} \geq \sqrt{2 ℓ} , and i = j\end{matrix} , or$$
$${\tilde{w}}_{ij} = \{ \begin{matrix}\frac{f}{ℓ {d}_{ij}} ; & {\tilde{d}}_{ij} < \sqrt{2 ℓ} \\ 0 ; & {\tilde{d}}_{ij} \geq \sqrt{2 ℓ} , and i = j\end{matrix} .$$

12. The system of claim 9, wherein the causation functions comprise one or more of an internal heating function, an initial condition, and a boundary heating function.

13. The system of claim 9, wherein generating an network graph of the object based on the node representation comprises:
defining layers of nodes by sorting nodes of the node representation based on respective z-coordinates of the nodes;
defining hatches of nodes by sorting the nodes of the node representation based on respective y-coordinates of the nodes;
defining blocks of nodes by sorting the nodes in each hatch and layer into discrete blocks; and
building the network graph based on relationships between the nodes.

14. The system of claim 9, wherein the representation of the estimated heat distribution within the object comprises a representation of heat flux within the object.

15. The system of claim 9, wherein the representation of the estimated heat distribution within the object comprises a representation of temperature distribution within the object.

16. One or more non-transitory computer readable storage media storing instructions that, when executed by at least one processor, cause the at least one processor to perform operations comprising:
converting a model of an object into a node representation of the object;
generating a network graph of the object based on the node representation;
for each block of nodes in the node representation:
applying a simulated heat to the block of nodes by multiple causation functions,
performing an energy balance of heat flow into and out of the node to determine the energy stored in the node, and
estimating a diffusion of heat to other nodes using physics based edge weights between nodes in the network graph; and
generating a representation of an estimated heat distribution within the object.

17. The computer readable storage media of claim 16, the operations further comprising assembling node equations from energy balance relations at each node into a Laplacian matrix.

18. The computer readable storage media of claim 16, wherein generating an network graph of the object based on the node representation comprises:
defining layers of nodes by sorting nodes of the node representation based on respective z-coordinates of the nodes;
defining hatches of nodes by sorting the nodes of the node representation based on respective y-coordinates of the nodes;
defining blocks of nodes by sorting the nodes in each hatch and layer into discrete blocks; and
building the network graph based on relationships between the nodes.

19. The computer readable storage media of claim 16, wherein the representation of the estimated heat distribution within the object comprises a representation of heat flux within the object.

20. The computer readable storage media of claim 16, wherein the representation of the estimated heat distribution within the object comprises a representation of temperature distribution within the object.
